(19) United States
(12) Patent Application Publication
(10) Pub. No.: US 2022/0269927 A1
(43) Pub. Date: Aug. 25, 2022

(54) OPTIMIZING MACHINE LEARNING

(71) Applicant: Meta Platforms, Inc., Menlo Park, CA (US)

(72) Inventors: Tristan Alexander Rice, Seattle, WA (US); Shengming Wang, Kirkland, WA (US); Hassan Eslami, Kirkland, WA (US); Luhui Hu, Bellevue, WA (US); Wolfram Schulte, Bellevue, WA (US); Yinglong Xia, San Jose, CA (US); Daniel Nota Peek, San Mateo, CA (US)

(21) Appl. No.: 17/674,767

(22) Filed: Feb. 17, 2022

Related U.S. Application Data
(60) Provisional application No. 63/152,297, filed on Feb. 22, 2021.
(60) Provisional application No. 63/152,303, filed on Feb. 22, 2021.
(60) Provisional application No. 63/152,312, filed on Feb. 22, 2021.
(60) Provisional application No. 63/155,217, filed on Mar. 1, 2021.

(51) Int. Cl. G06N 3/04; G06N 5/02; G06F 40/20; G06F 16/28

(52) U.S. Cl. CPC G06N 3/0454; G06N 5/02; G06F 40/20; G06F 16/283

(57) ABSTRACT

One embodiment is directed to training a machine-learning model using sample data by partitioning the machine-learning model into sub-portions and training the sub-portions in different nodes. Another embodiment is directed to training machine-learning models using features determined based on different data layers. Another embodiment is directed to determining a validity of a request for accessing data based on the processing results of policy modules. Another embodiment is directed to a policy engine including a policy knowledge module and a policy intelligence module. Another embodiment is directed to a smart data warehouse using natural language processing and nested heterogeneous graphs to visualize results.

### PRIORITY

This application claims the benefit under 35 U.S.C. § 119(e) of U.S. Provisional Patent Application No. 63/152,297, filed 22 Feb. 2021, U.S. Provisional Patent Application No. 63/152,303, filed 22 Feb. 2021, U.S. Provisional Patent Application No. 63/152,312, filed 22 Feb. 2021, U.S. Provisional Patent Application No. 63/155,217, filed 1 Mar. 2021, which are incorporated herein by reference.

### TECHNICAL FIELD

This disclosure generally relates to machine learning, in particular, to training learning models. This disclosure generally relates to machine-learning models, in particular, to feature engineering based on graph learning. This disclosure generally relates to network security, in particular, to access control of internet content. This disclosure generally relates to graph learning, in particular, to graph learning based on data warehouse.

### BRIEF DESCRIPTION OF THE DRAWINGS

FIG. 1 illustrates an example system for training machine-learning models by allowing each trainer node to have a machine-learning model copy.

FIG. 2 illustrates an example system for training machine-learning models allowing each trainer node to have a sub-portion of the same machine-learning model.

FIG. 3 illustrates an example system using a hybrid method for training machine-learning model.

FIG. 4 illustrates an example method for training machine-learning model using pipeline parallelism.

FIG. 5 illustrates an example process for training a machine-learning model and applying the machine-learning model to applications.

FIG. 6 illustrates an example framework for a feature knowledge graph system.

FIG. 7 illustrates an example data model including multiple layers.

FIG. 8 illustrates an example architecture for representative feature system.

FIG. 9 illustrates an example method for generating features for machine-learning models based on multiple data layers.

FIG. 10 illustrates an example binary filter operator scheme.

FIG. 11 illustrates an example intelligence operator scheme.

FIG. 12 illustrates an example intelligent control management system.

FIG. 13 illustrates an example method for using intelligent control management system for access control.

FIG. 14 illustrates an example architecture of smart data warehouse based on nested heterogenous graphs.

FIG. 15 illustrates an example unified data model based on nested heterogeneous graph.

FIG. 16A illustrates an example bipartite graph.

FIG. 16B illustrates clustered results on the bipartite graph.

FIG. 17 illustrates an example method for using smart data warehouse based on nested heterogeneous graphs to analyze data.

FIG. 18 illustrates an example network environment associated with a social-networking system.

FIG. 19 illustrates example social graph.

FIG. 20 illustrates an example computer system.

### DESCRIPTION OF EXAMPLE EMBODIMENTS

Traditional machine-learning method may use model parallelism approach which allow each trainer to hold a copy of model parameters, read its own mini-batches from reader, and perform deep learning with elastic averaging (EASGD) update with center (dense) parameter server. The model parallelism method may allow the ML model to be copied onto different trainer nodes and trained separately. The training results of different model copies hosted by different trainer nodes may be aggregated later. Data parallelism method may allow the data to be split and to be used to train the multiple copies of the same ML model. The different copies of the ML model may have their model parameter synchronized with respect to each other. The system may maintain all copies of the ML model to be indicial and to have the same set of model parameters. During the training process, different ML model copies may be trained on different trainer nodes separately and may be synchronized to each other to get the correct training result. Tradition method for training ML model in this way may a bottle neck for scalability. Because the ML model to be trained is copied onto each trainer node, the number of trainer nodes may be limited because the technical difficulty in keeping a large number of training node in synchronization. When there is a large number of training nodes, the ML models on different nodes may fail to synchronize and fail the training process or even get worse over time.

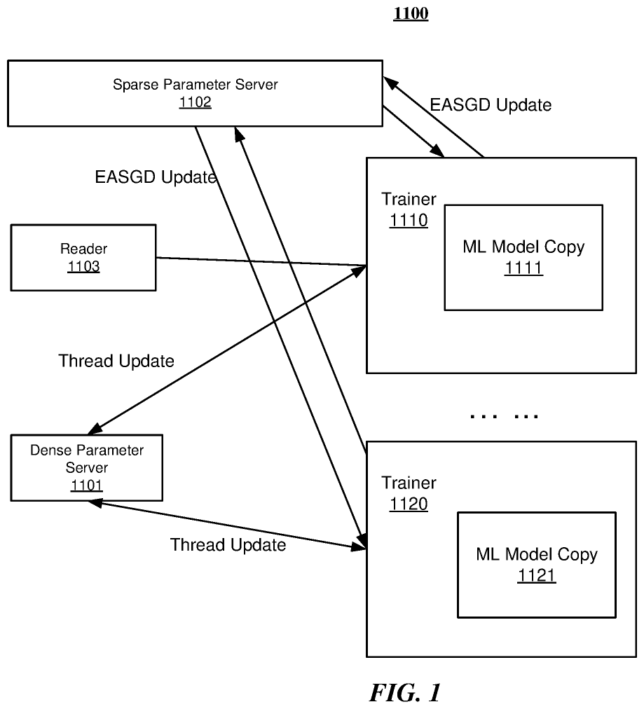

FIG. 1 illustrates an example system 1100 for training machine-learning models by allowing each trainer node to have a machine-learning model copy. As an example and not by way of limitation, the system 1100 may include a number of trainer nodes (e.g., 1110, 1120) each corresponding to a server. Each trainer node (e.g., 1110, 1120) may include a copy of the ML model to be trained (e.g., 1111, 1121). Each trainer node may access the training data through reader 1130. Each node may communicate with the sparse parameter server 1102 for thread update information and may communicate with the dense parameter server 1101 for EASGD update. During the training process, the ML model parameters may be synchronized through the dense parameter server. This method of training ML models may have limitation in the number of training nodes. When there is a large number of training nodes, the synchronization of the ML model parameters may fail which may lead to non-optimal training results.

ML model training in current CPU cluster may be bottlenecked on trainers' memory bandwidth. Particular embodiments of the system may partition the ML model across different nodes to “pipeline” executions and allow the ML model training to be scalable by simply adding trainers. ML model training may have non-negligible NE loss due to distributed SGD and EASGD limitations. Particular embodiments may use “pipelining” to circumvent both limitations and preserve model quality to solve this problem. When more trainers are used, traditional ML training may have stability issues such as NE explosion or may need other scaling techniques (Hierarchical Training) which requires extra “helper” nodes (intermediate) to accommodate the NE loss at the expense of efficiency loss. Particular embodiments of the system may solve this problem by using pipeline parallelism which needs no additional nodes. Particular embodiments of the system may break single host (GPU/CPU) memory limit by using pipeline parallelism instead of simple model parallelism

In particular embodiments, to solve the scalability problem in the traditional training approaches, the system may partition the ML model that need to be trained into different sub-portions and allow each trainer node to host a sub-portion of the ML model to be trained on that trainer node. The system may partition the ML model into different sub-portions based on model layers. For example, if a ML model has 10 layers, the system may partition the ML model into two sub-portion each having 5 layers. As another example, for a ML model having 10 layers, the system may partition that ML model into 10 sub-portions each having 1 layer. The ML model may be automatically partitioned into sub-portions with an overall optimization strategy, as discussed in later section. Because each trainer node may have a sub-portion of the ML model, the trainer nodes together may collectively host one single ML model (rather than each hosting a different copy of the ML model) and the ML model parameters of different sub-portions may need not to be synchronized (because there is only one ML model copy).

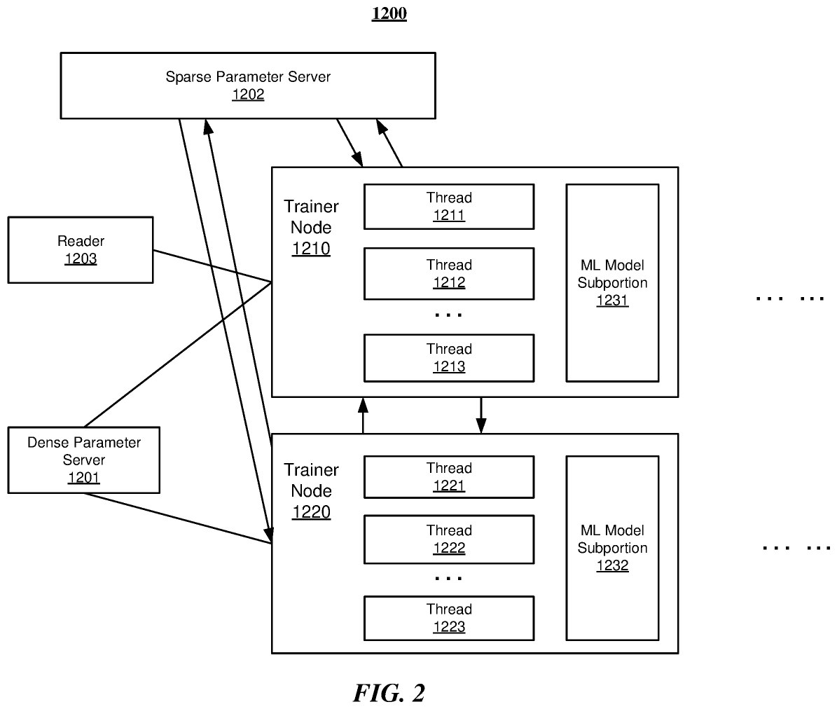

FIG. 2 illustrates an example system 1200 for training machine-learning models allowing each trainer node to have a sub-portion of the same machine-learning model. As an example and not by way of limitation, the system 1200 may include a number of trainer nodes each hosting a different sub-portion of the same ML model to be trained. For example, the trainer node 1210 may host the ML model sub-portion 1231 and the trainer node 1220 may host the ML model sub-portion 1232. Each trainer node may use a number of threads to train the corresponding ML model sub-portion. For example, the trainer node 1210 may include the threads of 1211, 1212, 1213, etc., which can parallelly access data and update the model parameters in the ML model sub-portion 1231 in an asynchronized manner to speed up the training process. For example, the treads may be hogwild treads. As another example, the trainer node 1220 may include the threads of 1221, 1222, 1223, etc., which can parallelly access data and update the model parameters in the ML model sub-portion 1232 in an asynchronized manner.

The trainer nodes (e.g., 1210, 1220) may access the training data though the reader 1203 and access the thread information through the sparse parameter server 1202. However, because the trainer nodes or trainer node may collectively host a singe ML model copy and the different sub-portions are of the same ML copies, the different sub-portions hosted by different trainer nodes may not need to be synchronized with respect to each other for the parameter weight values. As a result, the computation and communication performed by the dense parameter severs for the synchronization purpose may be significantly reduced or eliminated. And, the non-optimal training result caused by failing to synchronize the model parameters may be avoided. It is notable that although two trainer nodes are used in this example, the number of the trainer nodes is not limited thereto. For example, the system may have any suitable number of trainer nodes and the system for training ML models in this way can be scaled to a large number of trainer nodes. During the process, the different trainer nodes may still communicate with each other to coordinate the training process. For example, the trainer nodes 1210 and 1220 may host the ML model sub-portions 1231 and 1232, respectively. During the training process, the trainer nodes 1210 and 1220 may communicate with each other for training progress status. For example, the trainer nodes 1210 and 1220 may send an update message to each other each time a layer has been trained.

In particular embodiments, the system may use a hybrid method of pipeline parallelism and the method which allows different trainer nodes to have copy of the ML model, to train ML models. The system may partition the ML model into different sub-portions (e.g., each portion including some particular layers of the ML model) to be hosted on different trainer nodes. Trainer nodes (e.g., a server) hosting ML model sub-portion may be referred to as trainer pipes. The system may include a number of trainer nodes corresponding to different trainer pipes. In particular embodiments, one trainer node may correspond to one trainer pipe. In particular embodiments, one trainer node may be further be split into different trainer pipes (e.g., each pipe corresponding to a virtual server hosted by that trainer node). In particular embodiments, the system may allow the multiple trainer node to form a trainer that hosting the same ML model with each trainer node within the same trainer to host a different sub-portion of the ML model. The system may include different trainers and allow each trainer to host a copy of the same ML model, and allow each trainer node within the same trainer to host a different sub-portion of the same ML model copy hosted by that trainer. The system may use a EASGD-hogwild paradigm and may allow each trainer node to have multiple threads. Each hogwild thread may be logically partitioned across different pipes as well. The system may also allow the dense parameters to be split across different pipes.

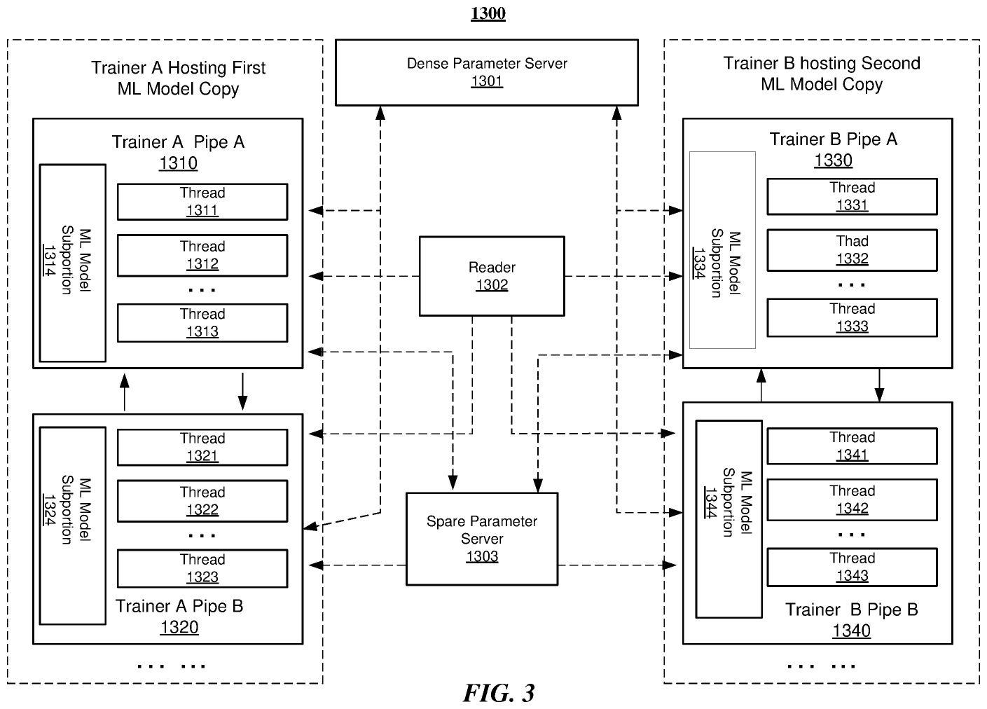

FIG. 3 illustrates an example system 1300 using a hybrid method for training machine-learning model. As an example and not by way of limitation, the system 1300 may include a number of trainers (e.g., trainer A, trainer B) each include multiple trainer pipes (e.g., pipe A, pipe B). Each trainer pipe may correspond to a server hosting a different sub-portion of the ML model of a particular copy of the ML model. For example, the trainer A (including trainer A pipe A and trainer A pipe B) may host a first copy of the ML model, which is partitioned into different sub-portions with trainer A pipe A hosting a first sub-portion of the first copy of the model and trainer A pipe B hosting a second sub-portion of the first copy of the model. The trainer B (including the trainer B pipe A and trainer B pipe B) may host a second copy of the ML model which may be portioned into different sub-portions. The trainer B pipe A may host a first sub-portion of the second ML model copy and the trainer B pipe B may host a second sub-portion of the second ML model copy. In other words, the trainer A pipe A and trainer A pipe B may host different sub-portions of the same first ML model copy. The trainer B pipe A and trainer B pipe B may host different sub-portions of the same second ML model copy.

During the training process, each trainer pipe may access the training data through the reader 1302 and access the thread information through the sparse parameter sever 1303. At the same time, each trainer pipe within the same trainer (e.g., pipe A and pipe B within the trainer A) may communicate with each other for the purpose of updating the training progress. However, the different pipes of the same within may not need to synchronize the model parameters because they are hosting different sup-portions of the same ML model copy (rather than different ML model copies). For example, the pipe A and pipe B of the trainer A may not need to synchronize their model parameters because each of them hosts a different sup-portion of the same ML model. Similarly, the pipe A and pipe B of the trainer B may not need to synchronize their model parameters because each of them hosts a different sub-portions of the same ML model copy.

However, because different trainers (e.g., trainer A and trainer B) are hosting different ML model copies, they may need to synchronize the ML model parameters during the training process to keep the ML model parameters to be the same for all the ML model copies. For example, the trainer A may communicate with the dense parameter server 1301 to update the ML model parameters during the training process. Similarly, the trainer B may communicate with the dense parameter server 1301 to update the ML model parameters during the process. The dense parameter server 1301 may aggregate all the ML parameter training results (e.g., intermediate training results) from all trainers and communicate with each trainer pipe of each trainer to keep the ML model parameters to be synchronized. The arrows between pipe A and pipe B may indicate the communication that are needed for process dependency between training of different pipes. Training process of different sub-portion of the ML model may dependent from each other (e.g., training order and timing of different layers). However, as discussed above, the model parameters of different sub-portions may not need to be synchronized. As a result, the system may reduce the bandwidth for synchronization and reduce the risk of non-synchronized ML model copies and overcome the bottle neck that limits the number of model copies, and provide an effective ML model training solution that is scalable.

In particular embodiments, the system may use an avant-garde distributed execution paradigm for Sparse Neural Network training by introducing pipeline parallelism in the current mix of data- and model-parallel approach. In particular embodiments, the system may use carefully designed partition methods to achieve approximately linear scalability with pipeline parallelism on current CPU clusters with significant better NE (model quality) compared with simply adding trainers. In particular embodiments, the system may achieve 60% qps boost with neutral NE on offsite CVR model which suffers from big NE loss when simply scaled by adding trainers in current settings. In particular embodiments, the system may use a novel co-design approach for SNN arch with graph partitioning algorithms in addition to using pipeline parallelism.

In particular embodiments, the system may include a number of trainers and parameter servers. ML model to be trained may be replicated across each trainer. Parameter servers may be all located on a single machine and may communicate with multiple trainers. For pipelining, the system may use a hybrid of the two approaches. The system may place computation on another machine (like a PS) but replicate the weights (like a trainer). The system for supporting trainers and parameter servers may involve tagging specific ops in a net and then slicing them up and placing them on different machines. The edges between operators may be replaced with a SendOp on the source node and a RecvOp on destination node. This may result in the same graph executing but spread across multiple machines.

In particular embodiments, to support pipelining, the system may modify the net generation code in order to 1) add more machines, 2) place some of ops (including weights+init ops) on the new machines. The system may spread computation across multiple machines and add some latency per batch. The system may run with more hogwild threads than strictly necessary so that the ML training process may saturate the machines. The system may increase latency quite a bit and while still having the same NE. If the system cannot fully utilize the added pipeline servers, the system may decouple the number of pipeline servers from the number of trainers. For example, the system may have 10 trainers but have only 5 additional pipeline servers. This may increase utilization on the pipeline servers and can improve efficiency for models that are hard to fully pipeline while still being able to take advantage of the added computational power.

As an example and not by way of limitation, the system may use the following implementation for organizing the ML model training process:

```
op {
  name: “SparseLookup”
  device_options {
    node_name: “component:”
  }
  input: “ids”
  output: “embedding”
}
op {
    name: “FC”
  device_options {
    node_name: “pipeline:a”
  }
  input: “embedding”
  output: “intermediate”
}
op {
  name: “ReLU”
  device_options {
    node_name: “pipeline:b”
  }
  input: “intermediate”
  output: “prediction”
}
op {
  name: “Loss”
  device_options {
    node_name: “pipeline:b”
  }
  input: “label”
  input: “prediction”
  output: “loss”
}
```

In particular embodiments, the system may use a single pipeline server or other model architectures that can better take advantage of deep network support. The system may use a new pass when generating the nets for each trainer to check if there are any pipeline tagged ops. The system may create a new trainer node and may place these pipelines tagged ops on that node. Since the pipeline servers are treated as trainers internally, the system may leverage the existing EASGD sync logic without modifications. Once the nets per trainer are generated, the system may get passed through the partitioning step to slice them up and generate the per node plans.

In particular embodiments, net transforms may refer to the automated transformations to a tagged Caffe2 network. The system may have a number of existing tags that indicate special behavior for certain operators. For example, component tagging which indicates the operator may be placed on a parameter server. As another example, device tagging which indicates the operator may be placed on a GPU instead of CPU. The system may add support for pipelining by adding a new parametric tag “pipeline” which indicates that the operator may be placed on a new pipeline server instead of a trainer.

In particular embodiments, the system may use an optimization process to partition the ML model considering balancing a number of factors. For example, each machine may need to balance the workload. The system may run the optimization process for training ML model using both model copies and pipes. Dense parameter server may be used to synchronize different training, the weights, the models. Each trainer may upload its training result to the dense parameter server. The trainer may be synchronized through the centralized synchronization for weights of models. The system may use the new solution to reduce the amount dense server. The sparse parameter server may be used to serve information related to data identification information. The reader may read the data and preprocess before providing to trainer.

In particular embodiments, the system may use two steps to determine which ops to place on the pipeline servers. First, the system may infer the computational cost of each op and the communication cost of edges in the net, and then run a graph partitioning algorithm to decide where to place the operators. For operator cost estimation, Caffe2 may have some support for inferring this information but it may be fairly limited and fragile. To get more accurate information, the system may reliably get this information for all models the system can train. The system may run a small version of the model and then extrapolates the profiling results to the full size one. Then, the system may use the graphcut algorithm to caffe2 net. Given the operator costs (vertex weight) and blob sizes (edge weight), the system may build a partition that minimizes “edge cut” which is equivalent to network traffic between “pipeline” servers, and also balance the aggregate operator cost in pipeline servers the same time.

Given a directed cyclic connected graph G, the system may have 2 types of vertices: C type (compute op) and N type (network). Each vertex may be assigned a weight (cost). The system may partition the graph into 2 subgraphs A and B with the optimization goals as following (arranged from high to low priorities). First, the system may minimize edge weights across partitions. Second, the system may maximize min{PartA compute nodes cost, PartB compute node costs}—in other words, balance compute cost. Third, the system may maximize min{PartA network nodes cost, PartB network nodes costs}—in other words, balance sparse lookup/network cost. Fourth, the system may have: (1) P as the set of all directed paths in G, (2) p_i as each path, and (3) e_i as the set of edges in p_i that cross PartA and PartB, minimize_P{max{∥e_i∥} }. The system may, among all paths in G, minimize execution latency. Fifth, the system may have the number of edges between A and B need to be minimized. The fourth and fifth goals may be relaxed because the training system is intrinsically “throughput.” Also the overhead of Send/Recv blobs may be negligible compared with blobs transferred. Thus, the system may safely relax the latency constraints of fourth goal. As for the fifth goal, the system may use the caffe2 net characteristics.

In graph theory, undirected graph min-cut problem may be a natural fit for this problem. The system may use a solution including Fiedler vector—the 2nd smallest eigenvector of undirected graph's Laplacian matrix. For the problem here, the problem may be integer quadratic programming similar to standard QCQP, shown as following:

$$( 1 )$$

$$minimize \frac{1}{2} {x}^{T} {P}_{0} x + {q}_{0}^{T} x subject to \frac{1}{2} {x}^{T} {P}_{i} x + {q}_{0}^{T} x + {r}_{i} \leq 0 for i = 1 , … , m , Ax = b ,$$

where P₀, . . . , Pₘ are n-by-n matrices and x∈Rⁿ is the optimization variable.

It is notable that the graphcut quadratic programming problem may be non-convex. The typical solution may be to relax it to convex case (SDP) and solve a lower bound of original non-convex problem. In particular embodiments, the system may apply a quite different approach from SDP. The system may directly solve the non-convex quadratic programming problem using Xpress's SLP solver (successive linear programming), which empirically gives close-to-optimal solutions. This quadratic programming approach may need to provide a UB/LB for variables. The non-convex graphcut problem may be sharp at integer boundaries. For example, assuming “x” is the continuous variable local/global minima, its integer rounding “sign(x)” may be 10× worse (greater) than it. The system may deal with these challenges with using heuristic refinement method in graphcut approach.

In particular embodiments, the system may achieve an edge cut of 1/100 of total blob sizes. In other words, if a dense net of v0 model is 1 GB (which is an overestimation of current models), the system may only need to transfer 10 MB per iteration. The system may provide an effective solution to address the edge-cut which may be the primary limiting factor that hinders pipelining to reach identical QPS to simply “trainer-scale-out.” The system may provide an effective solution for balancing limiting factors and provide an effective solution to partition the compute nodes relatively “evenly” (e.g., within a threshold range for evenness). The system may provide solution for further improvements of partitioning algorithm and arching change that can keep pushing the limiting factors to reach identical qps to simple “trainer-scale-out.” In particular embodiments, the system may provide effective solution in partition algorithm and arch changes so that pipelined trainers can achieve the same qps and equivalent amount of trainers. On model quality and training stability, the system may use shadowing mastercook runs, and may provide significant improvement in train stability.

TABLE 1
Scalability Test vs equivalent among of trainers
(simple EASGD scale-up)

| | | | Window | | NE Diff | |
|---|---|---|---|---|---|---|
| | | | pgs | | (5G | Num |
| | A | fid | p90 | Scalability | data) | ps |
| 1 | Baseline B | 199683415 | 25424 | l× | 0 | 35 |
| | trainers | | | | | |
| 2 | 16 trainers | 203981588 | 47007 | 1.84× | 0.16943 | 35 |
| 3 | 24 trainers | 203852511 | 69502 | 2.73× | 0.3219 | 49 |
| 4 | 30 trainers | 204262803 | 72420 | 2.84× | 0.3208 | 50 |
| 5 | | | | | | |
| 6 | Pipeline | | | | | |
| | group | | | | | |
| 7 | 8 * 2 pipeline | 203861109 | 40550 | 1.59× | −0.00555 | 35 |
| 8 | 12 * 2 | 203600073 | 56568 | 2.22× | 0.04512 | 45 |
| | pipeline | | | | | |
| 9 | 15 * 2 | 203600136 | 74191 | 2.91× | 0.12331 | 50 |
| | pipeline | | | | | |

In particular embodiments, the system may effectively process offsite_cvr_model which may be the most dense-heavy models and have the lowest qps among ML models of particular fields. Refer to previous analysis on EASGD scalability and HT analysis, the system may use pipelining to achieve linear scalability with the number of trainers. In large clusters like 30+ trainers, the system may use pipelining qps to provide comparable or better performance than the simple trainer-scale-out because parameter server becomes the scaling bottleneck. The system may provide NE curve of pipeline that is consistently much better than simple trainer-scale-out. The system may provide increased ESAGD sync. For example, in single trainer case, each trainer may need to sync all its dense parameters with dense server. In contrast, particular embodiments of this system may allow a pipelined node to only need to sync part of dense parameters. Thus the overall sync bandwidth with dense server is significantly increased. In particular embodiments, the system may provide reduced number of model copies, For example, experiments show that EASGD sync may not be the only cause of NE loss when adding trainers. In async model-parallelism training, the more trainers the system use the more SGD steps the system may “lose,” thus, the less efficient the SGD may be. By reducing the num of model copies, the system may help model converge better. Using a large amount of model copies may also cause NE “explosion.”

Table 2 shows a host-to-host network traffic distribution. In this table, “pipe1” node and “pipe2” node may form a two stage pipeline. network traffic is measured as “G bit/sec.” From the experimental results, it is notable that the biggest share of network bandwidth is the traffic between pipelines. Thus, the system may use reducing the “edge cut” as the key to improve pipeline performance.

TABLE 2
Average network traffic measured by “G bit/sec”

| | A | B | C | D |
|---|---|---|---|---|
| 1 | From/to | Pipe 1 | ps | Pipe 2 |
| 2 | Pipe 1 | | 3.79 Gb/s | 6.23 Gb/s |
| 3 | ps | 2.87 Gb/s | — | 1.39 Gb/s |
| 4 | Pipe 2 | 5.32 Gb/s | 1.38 Gb/s | — |
| 5 | reader | 854 Mb/s | — | — |

In particular embodiments, the system may adjust the neural net arch to reduce edge cut from 97 to 51. As shown in the experiment results, the system may increase qps without hurting NE. Also the measured network traffic is correlated with “edge cut.” In other words, the system's estimation method is accurate.

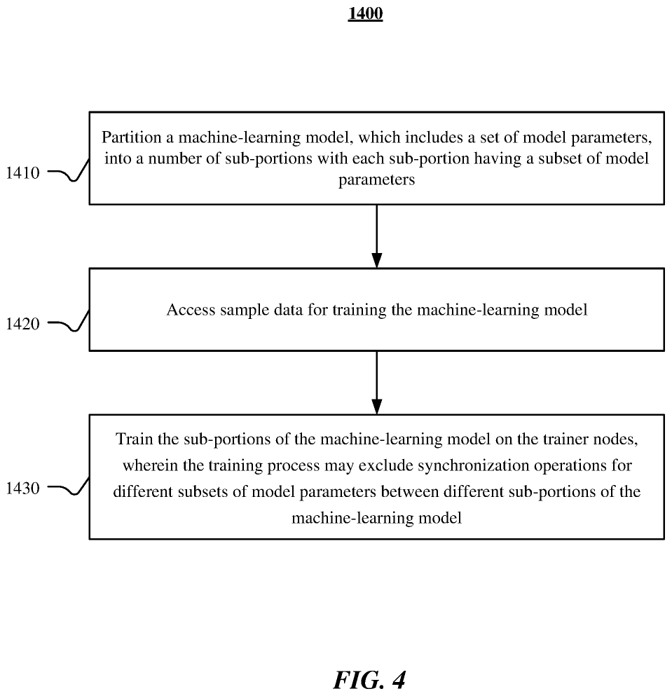

FIG. 4 illustrates an example method 1400 for training machine-learning model using pipeline parallelism. The method may begin at step 1410, where a computer system, which includes a number of trainer nodes, may partition a machine-learning model, which includes a set of model parameters, into a number of sub-portions with each sub-portion having a subset of model parameters. At step 1420, the system may access sample data for training the machine-learning model. At step 1430, the system may train the sub-portions of the machine-learning model on the trainer nodes. The training process may exclude synchronization operations for different subsets of model parameters between different sub-portions of the machine-learning model.

In particular embodiments, the system may partition the ML model that need to be trained into different sub-portions and allow each trainer node to host a sub-portion of the ML model to be trained on that trainer node. The system may partition the ML model into different sub-portions based on model layers. For example, if a ML model has 10 layers, the system may partition the ML model into two sub-portion each having 5 layers. As another example, for a ML model having 10 layers, the system may partition that ML model into 10 sub-portions each having 1 layer. The ML model may be automatically partitioned into sub-portions with an overall optimization strategy, as discussed in later section. Because each trainer node may have a sub-portion of the ML model, the trainer nodes together may collectively host one single ML model (rather than each hosting a different copy of the ML model) and the ML model parameters of different sub-portions may need not to be synchronized (because there is only one ML model copy).

In particular embodiments, the system may include a number of trainer nodes each hosting a different sub-portion of the same ML model to be trained. For example, the trainer node may host the ML model sub-portion and the trainer node may host the ML model sub-portion. Each trainer node may use a number of threads to train the corresponding ML model sub-portion. For example, the trainer node may include a number of threads which can parallelly access data and update the model parameters in the ML model sub-portion in an asynchronized manner to speed up the training process. For example, the treads may be hogwild treads. As another example, the trainer node may include a number of threads, which can parallelly access data and update the model parameters in the ML model sub-portion in an asynchronized manner.

In particular embodiments, the trainer nodes may access the training data though the reader and access the thread information through the sparse parameter server. However, because the trainer nodes or trainer node may collectively host a singe ML model copy and the different sub-portions are of the same ML copies, the different sub-portions hosted by different trainer nodes may not need to be synchronized with respect to each other for the parameter weight values. As a result, the computation and communication performed by the dense parameter severs for the synchronization purpose may be significantly reduced or eliminated. And, the non-optimal training result caused by failing to synchronize the model parameters may be avoided. During the process, the different trainer nodes may still communicate with each other to coordinate the training process. For example, the trainer nodes may host the respective ML model sub-portions. During the training process, the trainer nodes and may communicate with each other for training progress status. For example, the trainer nodes and may send an update message to each other each time a layer has been trained.

In particular embodiments, the system may use a hybrid method of pipeline parallelism and the method which allows different trainer node to have copy of the ML model, to train ML models. The system may partition the ML model into different sub-portions (e.g., each portion including some particular layers of the ML model) to be hosted on different trainer nodes. Trainer nodes (e.g., a server) hosting ML model sub-portion may be referred to as trainer pipes. The system may include a number of trainer nodes corresponding to different trainer pipes. In particular embodiments, one trainer node may correspond to one trainer pipe. In particular embodiments, one trainer node may be further be split into different trainer pipes (e.g., each pipe corresponding to a virtual server hosted by that trainer node). In particular embodiments, the system may allow the multiple trainer node to form a trainer that hosting the same ML model with each trainer node within the same trainer to host a different sub-portion of the ML model. The system may include different trainers and allow each trainer to host a copy of the same ML model, and allow each trainer node within the same trainer to host a different sub-portion of the same ML model copy hosted by that trainer. The system may use an EASGD-hogwild paradigm and may allow each trainer node to have multiple threads. Each thread may be logically partitioned across different pipes as well. The system may also allow the dense parameters to be split across different pipes.

In particular embodiments, the system may include a number of trainers (e.g., trainer A, trainer B) each include multiple trainer pipes (e.g., pipe A, pipe B). Each trainer pipe may correspond to a server hosting a different sub-portion of the ML model of a particular copy of the ML model. For example, the trainer A (including trainer A pipe A and trainer A pipe B) may host a first copy of the ML model, which is partitioned into different sub-portions with trainer A pipe A hosting a first sub-portion of the first copy of the model and trainer A pipe B hosting a second sub-portion of the first copy of the model. The trainer B (including the trainer B pipe A and trainer B pipe B) may host a second copy of the ML model which may be portioned into different sub-portions. The trainer B pipe A may host a first sub-portion of the second ML model copy and the trainer B pipe B may host a second sub-portion of the second ML model copy. In other words, the trainer A pipe A and trainer A pipe B may host different sub-portions of the same first ML model copy. The trainer B pipe A and trainer B pipe B may host different sub-portions of the same second ML model copy.

During the training process, each trainer pipe may access the training data through the reader and access the thread information through the sparse parameter sever. At the same time, each trainer pipe within the same trainer (e.g., pipe A and pipe B within the trainer A) may communicate with each other for the purpose of updating the training progress. However, the different pipes of the same within may not need to synchronize the model parameters because they are hosting different sup-portions of the same ML model copy (rather than different ML model copies). For example, the pipe A and pipe B of the trainer A may not need to synchronize their model parameters because each of them hosts a different sup-portion of the same ML model. Similarly, the pipe A and pipe B of the trainer B may not need to synchronize their model parameters because each of them hosts a different sub-portions of the same ML model copy.

However, because different trainers (e.g., trainer A and trainer B) are hosting different ML model copies, they may need to synchronize the ML model parameters during the training process to keep the ML model parameters to be the same for all the ML model copies. For example, the trainer A may communicate with the dense parameter server to update the ML model parameters during the training process. Similarly, the trainer B may communicate with the dense parameter server to update the ML model parameters during the process. The dense parameter server may aggregate all the ML parameter training results (e.g., intermediate training results) from all trainers and communicate with each trainer pipe of each trainer to keep the ML model parameters to be synchronized. The arrows between pipe A and pipe B may indicate the communication that are needed for process dependency between training of different pipes. Training process of different sub-portion of the ML model may dependent from each other (e.g., training order and timing of different layers). However, as discussed above, the model parameters of different sub-portions may not need to be synchronized. As a result, the system may reduce the bandwidth for synchronization and reduce the risk of non-synchronized ML model copies and overcome the bottle neck that limits the number of model copies, and provide an effective ML model training solution that is scalable.

Particular embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates an example method for training machine-learning models using pipeline parallelism including the particular steps of the method of FIG. 4, this disclosure contemplates any suitable method for training machine-learning models using pipeline parallelism including any suitable steps, which may include all, some, or none of the steps of the method of FIG. 4, where appropriate. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

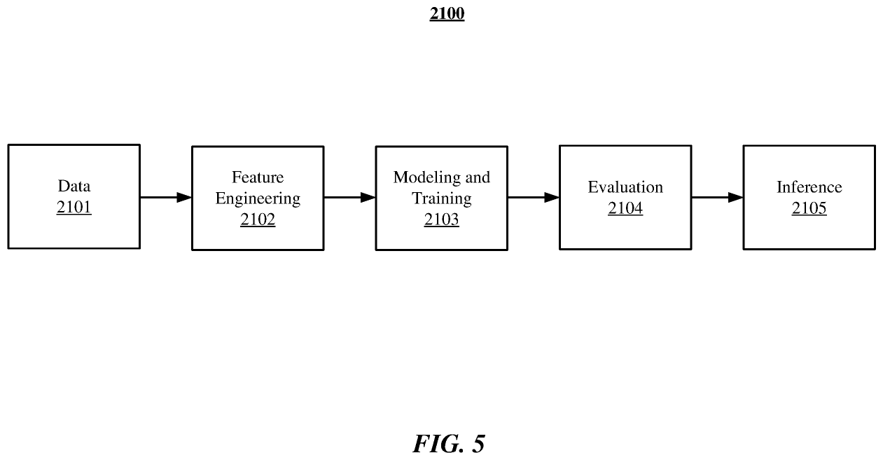

FIG. 5 illustrates an example process 2100 for training a machine-learning model and applying the machine-learning model to applications. A machine-learning (ML) model may need a number of features to be effectively trained and to be applied to applications. These features may play a critical role in the training efficiency and model accuracy of the ML model. Feature engineering 2102 may be the process of using domain knowledge or data driven techniques to extract and create features for ML models. As an example, feature engineering may be performed by human experts to determine features for a ML model based on the domain knowledge associated with that ML model. As another example, the system may use data driven techniques (e.g., feature extracting algorithms) to extract or generate features for a ML model from data 2101 collected from the associated problem domain. The determined features may be used in a modeling and training process 2103 to create a ML model or/and train the ML model based on these features. Then, the determined features and corresponding ML models may be evaluated in an evaluation process 2104. After that, in an inference stage 2105, the determined features and corresponding ML models may be applied to applications.

Feature engineering is a process for generating features for machine-learning (ML) models of specific problem domains to be used in the training and inference processes of the ML models. Existing techniques for feature engineering are complex and inefficient for several reasons. First, features are usually associated a specific problem domain and cannot be easily reused in a different problem domain. Second, although inference results may be used for generating and updating features, there is no effective mechanism to evaluate effectiveness of features and determine their relevance to a particular model. Third, when ML models become more complicated (e.g., multiple-tower models, multi-task models, multi-stage models) and there is no effective mechanism for automatically discovering feature knowledge (e.g., relationships, relevance, and importance) between features and models of different problem domains, different towers or different tasks. Fourth, features may be organized by different feature groups and feature layers and there is no effective mechanisms to discover the relationships between the features of different groups or layers. In addition, for some problem domains, there may be a large amount of data that needs to be processed to determine the features for the ML models in these problem domains. As a result, in many ML use cases, it could be very time and effort consuming for data scientists and ML engineers to determine appropriate features for ML models during the feature engineering process.

Machine learning often may work well for a specific problem domain. Feature engineering may be a complex process when there is a huge amount of data even for a specific problem domain. Deep learning can help reduce the effort of feature engineering, but it's still a complicated process for feature engineering in a large-scale domain. For simplifying the process of feature engineering and reusing features, the features may be categorized into, for example different feature groups. Data and features may be divided into different layers, such as, fundamental data (through pre-processing raw data), generic features, domain features, and application features. Besides classifying and layering features, particular embodiments of the system may use a data/feature sharing mechanism like App Store. However, it is still limited to creating better features for better models and it may be time-consuming for feature engineering to feed optimized features to a model. The process may have difficulties to understand a model when employing a large number of features.

In particular embodiments, features may be generated through data pre-processing and may be bound to specific problem domains. The systems may lack of information or knowledge to systematically represent features along with the problem domain context. Thus, without high-quality attributes to describe features, it can be hard for the system to reuse the features effectively and share across problem domains. There might be many data and features used for a model and there might be many models orchestrated for a problem domain. It can be hard for the system to iterate and represent all the features and models for reusing and optimizing features. In particular embodiments, the system described in this disclosure may provide an effective solution to iterate and represent all the features and models for reusing and optimizing purpose.

In particular embodiments, there may be several steps in ML model lifecycle, ranging from data pre-processing, feature engineering, training, to serving, etc. Signals in each step/process can be important for upstream and downstream, but there might be no efficient way to connect all of them. Features can be critical for modeling and serving. But the system may lack an effective mechanism to evaluate/review features according to the inference results of a model. In particular embodiments, the system described in this disclosure may provide an effective mechanism to evaluate/review features according to the inference results of a model.

In particular embodiments, the system may process more and more data using machine learning techniques, and models may become more complicated models including, for example but not limited to, multi-tower models, multi-task models and multi-stage models. However, it can be challenging to systematically identify the importance of the features and the relationship of features with respect to a tower model, a task model, or a stage sub-model. And, it can be challenging to differentiate two similar features or feature groups. Similarly, it can be challenging to imply to another feature based on one feature. In particular embodiments, the system described in this disclosure may provide an effective solution to group features using feature groups and layer the features based on different scopes for managing features and reusing features.

To solve these problems, particular embodiments of the system may use a knowledge graph to automatically determine features for ML models. The system may generate a knowledge graph to represent the relationships between a number of ML models and a number of features associated with these ML models. The system may use graphic neural networks or rule-based intelligent logics to learn new knowledge (e.g., relationships, similarity, importance, relevance, correlations) about these models and features based on the knowledge graph. The system may dynamically update the knowledge graph based on new knowledge learned through graph learning. During a feature engineering process, the system may receive query information associated with a particular ML model and may use the knowledge graph to determine features for that particular ML model. The system may recommend new features for a ML model to improve the effectiveness and precision of that ML model. The system may receive inference value metrics that reflect the importance or effectiveness of the corresponding model inference in respective applications and use the inference value metrics to determine the weight of the edges in the knowledge graph. As a result, the system may provide an effective solution for automated feature engineering using a knowledge graph and graph learning.

By using the knowledge graph for feature engineering, particular embodiments of the system may allow the feature engineering process to be more effective and efficient. By using graph learning based on the knowledge graph, particular embodiments of the system may discover hidden correlations between ML models and features that are not obvious to human experts. For example, using the graph structure, the features in different problem domains, different feature groups or layers may be linked with meaningful relationships. By using the knowledge graph, particular embodiments of the system may allow the known features of the mass feature repository to be reused in different ML models and allow knowledge of the existing models to be used to new knowledge domain. By using the feature knowledge graph system, particular embodiments of the system may apply information related to effectiveness of inference features directly in a fine-grained way to improve training effectiveness of ML models.

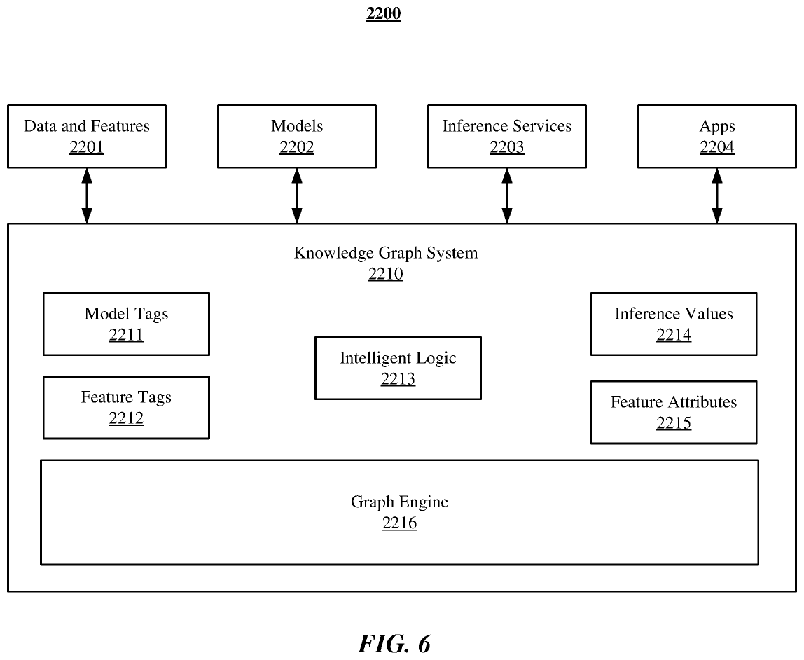

FIG. 6 illustrates an example framework 2200 for a feature knowledge graph system. In particular embodiments, the feature knowledge graph system 2210 may include a number of modules or sub-systems including, for example, but not limited to, a model tag module 2211, a feature tag module 2211, an intelligent logic module 2213, an inference value module 2214, a feature attribute module 2215, a graph engine 2216, one or more interface modules for data input and output, etc. The feature knowledge graph system 2210 may receive a number of ML models 2202 with associated data and features 2201 to generate a knowledge graph. In particular embodiments, the feature knowledge graph system 2210 may receive the ML models 2202 with associated data and features 2201 from other computing systems using APIs of one or more interface modules or from user inputs. The received ML models and features may be stored in the graph engine 2216. The graph engine 2216 may generate a knowledge graph based on these ML models and features. The feature knowledge graph system 2210 may generate one or more model tags for each ML model in the knowledge graph and may store the model tags in the model tag module 2211. The feature knowledge graph system 2210 may generate one or more feature tags for each feature in the knowledge graph and may store the feature tags in the feature tag module 2212. The feature knowledge graph system 2210 may use the model tags stored in the model tag module 2211 to access the corresponding models stored in the knowledge graph in the graph engine 2216. The feature knowledge graph system 2210 may use the feature tags stored in the feature tag module 2212 to access the corresponding features stored in the knowledge graph in the graph engine 2216.

In particular embodiments, the feature knowledge graph system 2210 may use the intelligent logic module 2213 to learn new knowledge through graph learning based on the knowledge graph. In particular embodiments, the intelligent logic 2213 may include one or more rule-based algorithms, statistic algorithms, or ML models (e.g., convolutional neural networks, graph neural networks). The intelligent logic module 2213 may identify new relationships and discover hidden relationships between features and ML models in the knowledge graph. The new knowledge (e.g., new relationships) learned by the intelligent logic module 2213 may be sent back to the graph engine 2216 to update the knowledge graph. The feature knowledge graph system 2210 may extract one or more feature attributes (e.g., feature groups, feature layers, feature stores, feature problem domains, etc.) for each feature and store the extracted feature attributes in the feature attribute module 2215. The feature attributes may allow features to be easily tagged in the graphs and allow all related information in the machine learning process to be captured in the knowledge graph. It is notable that the feature attributes stored in the feature attribute module 2215 as described here may be for helping build relationships in the knowledge graph. The features themselves may have many intrinsic attributes, such as data origins, creation dates, storage locations etc. These intrinsic attributes may be part of feature themselves other than the feature attributes as described here. In particular embodiments, the feature knowledge graph system 2210 may extract one or more model attributes for capturing information related to training and models. The model attributes may capture information related training efficiency or other model metrics including, for example, but not limited to, precision (e.g., average precision score (APS)), recall, receiver operating characteristic (ROC), area under the curve (AUC), logic loss function (LLF), etc. Both training efficiency and model metrics may be used to choose better features and adjust modeling.

In particular embodiments, the feature knowledge graph system 2210 may receive inference values of particular ML models with associated features and store the received inference values in the inference value module 2214. For example, the feature knowledge graph system 2210 may determine one or more features for an Ads recommendation model using the knowledge graph and deploy the Ads recommendation model with these features to the application 2204. The application 2204 may measure and track the inference values (e.g., click-through rates, exposure rates, conversion rates, revenuer per impress, conversion per impression) of the Ads recommendation model and send the inference values back to the feature knowledge graph system 2210. The feature knowledge graph system 2210 may use these inference values to determine or update the weight values in the knowledge graph. The feature knowledge graph system 2210 may provide inference services 2203 through one or more APIs or a user input/output module. The feature knowledge graph system 2210 may receive a user query related to a particular ML model (e.g., a new ML model or an existing ML model in the knowledge graph). The feature knowledge graph system 2210 may use graph learning to learn new knowledge (e.g., discovering new or hidden relationships of feature-model pairs, feature-feature pair, or model-model pairs) about that particular ML model being queried. The feature knowledge graph system 2210 may generate recommended features for that ML model based on the newly learned knowledge or newly discovered relationships. The recommended features may be generated based on features of other pre-existing models in the knowledge graph.

In particular embodiments, a knowledge graph as described in this disclosure may be a data structure containing knowledge and information to represent interactions (e.g., represented by edges) between individual entities (e.g., represented by nodes). In particular embodiments, knowledge graphs may be applied to recommendation systems, biological protein networks, social networks, etc. In particular embodiments, graphs including structured knowledge or data may be employed along with machine learning for feature information processing and feature serving during a feature engineering process. In particular embodiments, graph learning may naturally convert knowledge information across various entities into ML models for appropriate problems to facilitate inference solutions. In particular embodiments, graph neural networks (GNN) may extend convolutional neural networks (CNNs) with graph embedding and convolutions for solving non-Euclidean domain problems. In this disclosure, “a feature knowledge graph” may be referred to as “a knowledge graph” and may include knowledge information (e.g., relationship information) related to a number of ML models and a number of associated features stored in the graph. Examples of knowledge graphs and methods for using knowledge graphs to recommend features for machine-learning models are described in U.S. patent application Ser. No. 16/913,054, entitled “SYSTEMS AND METHODS FOR FEATURE ENGINEERING BASED ON GRAPH LEARNING” filed on 26 Jun. 2020, which is incorporated here as reference.

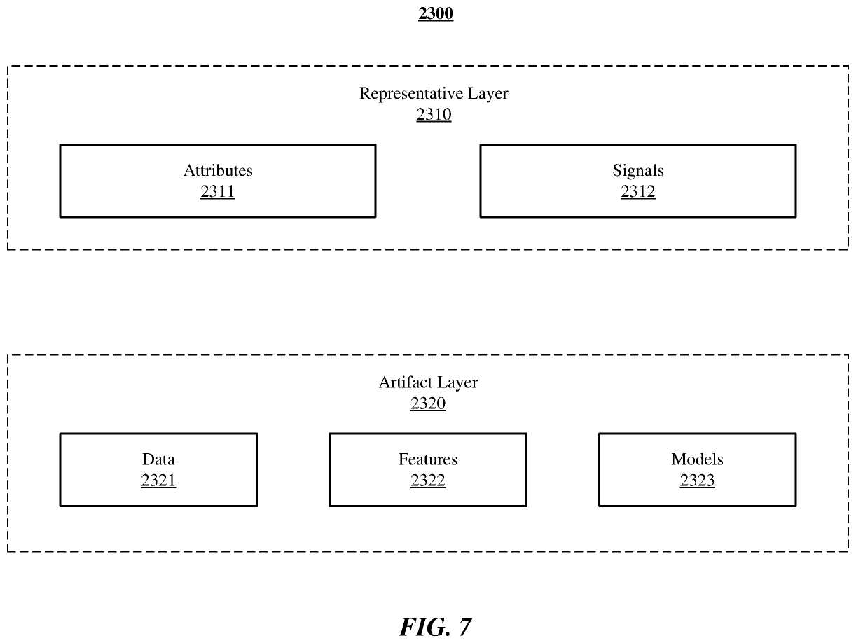

FIG. 7 illustrates an example data model 2300 including multiple layers. In particular embodiments, the system may process the feature engineering more effectively and productively by using an intelligent representative feature system on top of the feature knowledge graph system. Feature knowledge graph may be capable of finding the relevant features in a large volume of features, and a representative feature system may offer more effective features for machine learning models with critical data. In particular embodiments, the system may represent ML data using two layers: representative layer and artifact layer. As an example and not by way of limitation, the data model 2300 may include a representative layer 2310 and an artifact layer 2320. The representative layer 2310 may include attributes 2311 and signals 2312. The artifact layer 2320 may include data 2321, features 2322, models 2323, etc. The signals may include metadata and state information related to data preprocessing, training, serving, and user feedback. The attributes may represent datasets, features, models, and even signals. Both attributes and signals may be fine-defined features for machine learning and may be curated from the data in the artifact layer and can represent the data in the artifact layer.

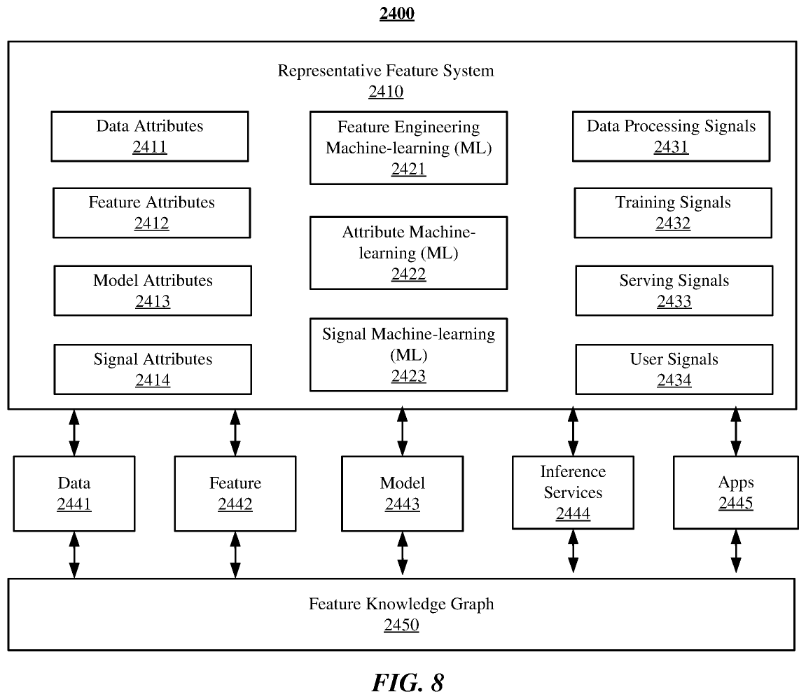

FIG. 8 illustrates an example architecture 2400 for representative feature system. As an example and not by way of limitation, the representative feature system 2410 may include a number of attribute modules including, for example but not limited to, data attributes 2411, features attributes 2412, model attributes 2413, signal attributes 2414, etc. The system may include a number of ML models including, for example but not limited to, feature engineering ML 2421, attributes ML 2422, signal ML 2423, etc. The system may include a number of signal modules including, for example but not limited to, data processing signals 2431, training signals 2432, serving signals 2433, user signals 2444, etc. In particular embodiments, the representative feature system 2410 may communicate with external modules through one or more communication interfaces. The external modules may include, for example, but not limited to, data module 2411, feature module 2442, model module 2433, inference services 2444, applications 2445, etc. In particular embodiments, the architecture 2400 may include a feature knowledge graph, which may be maintained by a knowledge graph system (e.g., 2200 in FIG. 6). The feature knowledge graph 2450 may share the same external modules of data module 2411, feature module 2442, model module 2433, inference services 2444, applications 2445, etc. The feature knowledge graph as hosted by the graph knowledge system may communicate and interact with the representative feature system 2410 directly or indirectly through the external modules.

In particular embodiments, the system may use 4 types of signals including, for example, but not limited to Data Preprocessing (DP) Signals, Training Signals, Serving Signals, and User Signals. These signals may be captured in the related 4 processes of data preprocessing, training, serving, user interaction, etc. These signals may be used for generating attributes and serving as features for training. With these first-hand signals, machine learning may have overall information in the ML process including user feedback. These signals may also help optimize the data pre-processing and training.

In particular embodiments, the system may use a number of types of attributes including, for example but not limited to, data attributes, feature attributes, model attributes, signal attributes, etc. The data attributes may represent data, features, and models in the artifact layer, and signals in the representative layer. The attributes may contain precise and concise feature information, which can be used for training as high-fidelity features. For example, a unique 100 MB feature data may be represented as a short attribute using a hash function in the classification, and then the feature data can be easier for sharing and more efficient for training. As another example, a complex text doc feature may be extracted by key terms as attributes for training. These attributes may be extracted and curated from the artifact layer and signals using ML or manually. As yet another example, the system may extract attributes from text features using natural language process (NLP), extract attributes from binary data using hashing, or extract attributes from voice data using automatic speech recognition (ASR) or speech to text (STT).

In particular embodiments, the intelligent graph-structured knowledge system may use machine learning algorithms (e.g., feature engineering ML) to simplify the logic of building graphs and predict attribute/signal features for training and inference. Intelligent logic may use smart edge and smart node and may be designed for smart feature serving in model training and inference.

In particular embodiments, attributes and signals may be entities in the knowledge and may be connected based on the related features, models, processes, etc. The graph knowledge system may be part of feature engineering and the knowledge information may be updated dynamically during the process. Thus, the attributes may be generated by the existing attributes, and signals using attribute ML logic (graph learning). Similarly, signal machine-learning may curate the signal related graph and generate more effective signals for feature engineering. Both machine-learning logic may help attributes and signals to form a related knowledge graph and generate new attributes and signals. But attributes ML and signal ML may be different ML models due to different data artifacts. In particular embodiments, both representative layer and the artifact layers may be intelligent knowledge systems having intelligent knowledge graphs. More details related to the knowledge graphs are described in U.S. patent application Ser. No. 16/913,054, entitled “SYSTEMS AND METHODS FOR FEATURE ENGINEERING BASED ON GRAPH LEARNING” filed on 26 Jun. 2020, which is incorporated here for reference.

In particular embodiments, facing the mass of data and features and the time-consuming process of feature engineering, the representative feature system provide an effective solution to these challenges. In particular embodiments, the feature engineering may become more effective and efficient using the representative feature knowledge system. The features from the representative layer may be more precise and concise for training and sharing. With a graph system, the related attribute/signal features may be extracted effectively for model training and serving allowing high-fidelity feature mining to be feasible and effective.

In particular embodiments, in the process of machine learning may include steps such as data preparation, feature engineering, modeling, training, serving, etc. It may be a waterfall process with feedback from inference results to data. With the feature attribute graph system, the effectiveness of inference may be applied to features directly in a fine-grained way that can help tune training efficiently. Signals in the representative layer may capture all states and values in different processes and may be used holistically for feature engineering. Using graph structure, the features in different feature groups and layers may be linked with meaningful relationships. Further, this information may be used for better feature engineering to get a better model. Models become more and more complicated, such as multi-layer model, multi-tower model, multi-task model and multi-stage model. Features may be related to models and sub-models. It could be important to reuse, relate and discover features among the mass feature repository. In particular embodiments, the representative feature system may use attributes to represent sub-models and make clearer relationships between features and models, and between features and sub-models for helping generate better models.

Transfer learning is a mechanism of machine learning to reuse the existing models by applying new domain knowledge in some layers of the models. On the other hand, transfer learning may be a way of feature engineering. In particular embodiments, the representative feature system may allow the sharing layers of the models to become more descriptive and more relative by tagging the features, thus may help to determine the layer design in transfer learning based on the feature attributes and domain knowledge. In particular embodiments, transfer learning for the models may be extended, for example, based on the existing English-to-Chinese model. In particular embodiments, transfer learning for the models may be extended for English-to-Japanese and German-to-Chinese models. In particular embodiments, the representative feature system may help to generate the feature set for applying to more effective domain knowledge layers using feature attributes. In particular embodiments, systems using the representative feature system may explicitly provide the primitives/APIs asking for attributes and the relationship between features, or models, etc. Graph systems may provide graph algorithms such as graph clustering, random walk, etc., to explore the entities and organize them properly.

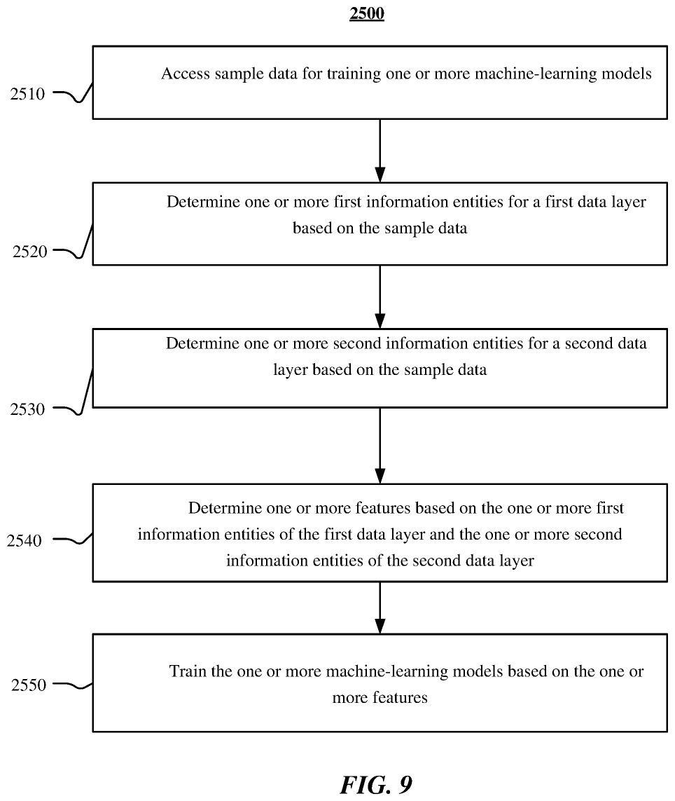

FIG. 9 illustrates an example method 2500 for generating features for machine-learning models based on multiple data layers. The method may begin at the step 2510, where a computing system may access sample data for training one or more machine-learning models. At step 2520, the system may determine one or more first information entities for a first data layer based on the sample data. At step 2530, the system may determine one or more second information entities for a second data layer based on the sample data. At step 2540, the system may determine one or more features based on the one or more first information entities of the first data layer and the one or more second information entities of the second data layer. At step 2550, the system may train the one or more machine-learning models based on the one or more features. In particular embodiments, the sample data and the one or more features may be cross multiple problem domains. In particular embodiments, the first data layer may be a representative layer, and the one or more first information entities may comprise one or more of: an attribute entity or a signal entity. In particular embodiments, the second data layer may be an artifact layer, and the one or more second information entities may comprise one or more of: a feature, a machine-learning model, or a data sample.

In particular embodiments, the system may use featuring engineering technology to generate features that can be used to train machine-learning (ML) models cross different problem domains. In particular embodiments, the system may use an intelligent representative feature system on top of a feature knowledge graph system to effectively determine the features for ML models. The system may use the feature knowledge graph to find the relevant features in a large volume of features and use the representative feature system to generate more effective features for machine learning models with critical data. The system may represent the ML data by two layers including representative layer and artifact layer. The representative layer may include attributes and signals. The signals can be related to metadata and states of data for preprocessing, training, serving, and user feedback. The attributes can represent datasets, features, models, and even signals. The artifact layer may include data, features, and models. Both attributes and signals may be fine-defined features for machine learning and may curated from the artifact layer and may be used to represent the data in the artifact layer. The system may use at least four types of signals including data preprocessing (DP) signals, training signals, serving signals, and user signals. These signals may be captured in the related processes including, for example, DP process, training process, serving process, and user interaction process. These signals may be used for generating attributes and serving as features for training. With these first-hand signals, machine learning models may have overall information in the ML process including user feedback. The system may optimize the data pre-processing and training.

In particular embodiments, the system may use different types of attributes including data attributes, feature attributes, model attributes, and signal attributes. The attributes may represent data, features, and models in the artifact layer, and signals in the representative layer. The attributes may contain precise and concise feature information, which may be used for training as high-fidelity features. For example, a unique 100 MB feature data may be represented as a short attribute using a hash function in the classification, and the attribute may allow the feature data to be easier for sharing and more efficient for training. As another example, the system may extract a complex text doc feature by key terms and use the complex doc as attributes for training. The system may extract and curate these attributes from the artifact layer and signals using ML or manually. For example, the system may extract attributes from text features using natural language processing (NLP) and may extract attributes from binary data using hashing, and extract attributes from voice data using automatic speech recognition (ASR) or speech to text (STT).

In particular embodiments, the system may have both layers to be or include intelligent knowledge systems with intelligent knowledge graphs. Attributes and signals may be entities in the knowledge graph, and may be connected based on the related features, models, and processes. The system may use the graph knowledge system as a part of feature engineering and may dynamically update knowledge information during the process. Thus, the attributes may be generated based on the existing attributes, and signals using attribute ML logic (e.g., graph learning). Similarly, signal ML logic may curate the signal related graph and generate more effective signals for feature engineering. Both ML logics may help attributes and signals to form a related knowledge graph and generate new attributes and signals. The attribute ML logic and signal ML logic may be different models due to different data artifacts. The system may use the intelligent graph-structured knowledge system which uses machine learning algorithms (e.g., feature engineering machine learning) to simplify the logic of building graphs and predict attribute/signal features for training and inference. The system may use intelligent logic for smart edge and smart node and the intelligent logic may be designed for smart feature serving in model training and inference.

In particular embodiments, the system may allow the features to be shared cross multiple problem domains. In particular embodiments, the system may allow feature engineering to effectively handle a huge amount of data for a specific problem domain or for multiple problem domains. In particular embodiments, the system may use deep learning to reduce the effort of feature engineering and allow the feature engineering process to performed effectively in a large-scale domain. In particular embodiments, the system may simplify the process of feature engineering and allow the features to be reused. In particular embodiments, the system may categorize the features into different feature groups and divide data and features into different layers including, for example but not limited to, fundamental data (e.g., through pre-processing raw data), generic features, domain features, and application features. Besides classifying and layering features, in particular embodiments, the system may build a data/feature sharing mechanism like App store. In particular embodiments, the system may create better features for better models and feed the optimized features to ML models.

In particular embodiments, the system may generate features through data pre-processing for specific problem domains. In particular embodiments, the system may systematically represent features along with the problem domain context. In particular embodiments, the system may generate high-quality attributes to describe features and allow the features to be reused and shared effectively across different problem domains. In particular embodiments, the system may process a large amount of data and a large number of features used for a model in deep learning. In particular embodiments, the system may include many models orchestrated for a problem domain. The system may effectively iterate and represent these features and models for feature reusing and optimizing purpose. In particular embodiments, the system may process and connect signals of different steps in ML model lifecycle, ranging from data pre-processing, feature engineering, training, to serving, etc., and make the signals to be efficiently reusable for upstream and downstream process. In particular embodiments, the system may provide an effective mechanism to evaluate/review features according to the inference results of a model. In particular embodiments, the system may use complicated ML models or sub-models including, for example, multi-tower model, multi-task model and multi-stage model for feature engineering. In particular embodiments, the system may systematically identify the importance of the features and the relationship of features with respect to a tower, a task, and a stage sub-model. In particular embodiments, the system may group features using feature groups and may layer the features based on different scopes for managing features and reusing features. In particular embodiments, the system may differentiate two similar features or feature groups and determine the relationship between one feature to another.

Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for generating features for machine-learning models based on multiple data layers including the particular steps of the method of FIG. 9, this disclosure contemplates any suitable method for generating features for machine-learning models based on multiple data layers including any suitable steps, which may include all, some, or none of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

Data may a critical asset for data-driven entities and may be the key to make the machine learning (ML) models to work. But data could be vulnerable to any attackers or improper uses. Access control may refer to the selective restriction of access to a resource. Access management may refer to the process of access control. The act of accessing data may refer to consuming data, entering a data storage, or using data. Permission to access a resource may be referred to as authorization. There could be many different mechanisms for data access controls due to the complex and dynamic situations.

In particular embodiments, the system may use two methods for managing access control for resources including role-based access control (RBAC) and attribute-based access control (ABAC). Both methods may be used for controlling the authentication process and authorizing users. The primary difference between RBAC and ABAC may be that RBAC may provide access to resources or information based on user roles, while ABAC may provide access rights based on user, environment, or resource attributes. Essentially, when considering RBAC and ABAC, RBAC may be used to control broad access across an organization, while ABAC may be used as a fine-grain approach. Generally, when RBAC will suffice, the system may use RBAC before setting up ABAC access control, because ABAC is generally the more complex and requires more processing power and time. In particular embodiments, the system may use a hybrid access control method combining both RBAC and ABAC to control the data access. In particular embodiments, the system may use the RBAC or/and ABAC for generic resource access controls. In particular embodiments, the system may use the RBAC or/and ABAC as risk control mechanisms.

Data and resources may become a challenge to have access control effectively. Due to complexity and scalability, there may be many access control methods, such as RBAC and ABAC. An effective access rights management system may be needed to make RBAC and ABAC work well. However, traditional technology for access right management may be obsolete and difficult to scale out. For example, traditional access control mechanisms may have been implemented by a coupled chunk of software and may be hard to maintain and change. Each change may need to update the code and deploy the service. In some applications, it could be important to have a smooth user experience to access a resource. Traditional technology may be less efficient to perform a thorough access control filtering. For example, traditional technology may take time to collect and update attributes for ABAC which could be time-consuming to execute a large-scale RBAC and ABAC. For example, a risk control check may take up to several minutes which could be too slow for large scale applications.

Traditional technology for access control would have difficulties to determine which one can have entire control or access over another. Furthermore, it would be challenging for traditional technologies to combine different methods or add another one in the implementation. In some applications, the resource control filtering paths may be the same for many accesses. It could be less efficient without information cache or process encapsulation and it could be time-consuming to identify and implement some policy logic and attributes, such as, privacy information in Hive tables identified by data classifiers. Unfortunately, for traditional technologies, it would be challenging to reuse this identified information and implement logic for another access control method or another “decision tree.” Furthermore, traditional technologies has no intelligent logic to improve the controls incrementally and predict any potential vulnerabilities for preventing in advance.

To solve these problems, particular embodiments of the system may use intelligent modular resource control management for access control. The system may include a number of main components in the intelligent control management including, for example but not limited to, policy operator, policy algorithm, policy flow, policy module, a policy engine, etc. In particular embodiments, a policy may refer to a deliberate system or component of principles to guide decisions and achieve rational outcomes. A policy may be a statement of intent and may be implemented as a procedure or protocol. The policy may be used here for generic control management. In particular embodiments, a policy operator may be the basic element for executing a policy and performing a filtering. The system may use at least four types of policy operators including, for example but not limited to, filtering operator, function operator, computing operator, intelligence operator, etc. The filtering operator may be basic operators for security check and filtering, for example, binary filtering operator (BFO), multi-filtering operator (MFO), attribute-based filtering operator (ABFO), etc. The function operator may have some built-in function for a standalone operator, for example, face-recognized operator (FRO), fingerprint operator (FPO), etc. The computing operator may provide a generic operator for any control logic as a unit.

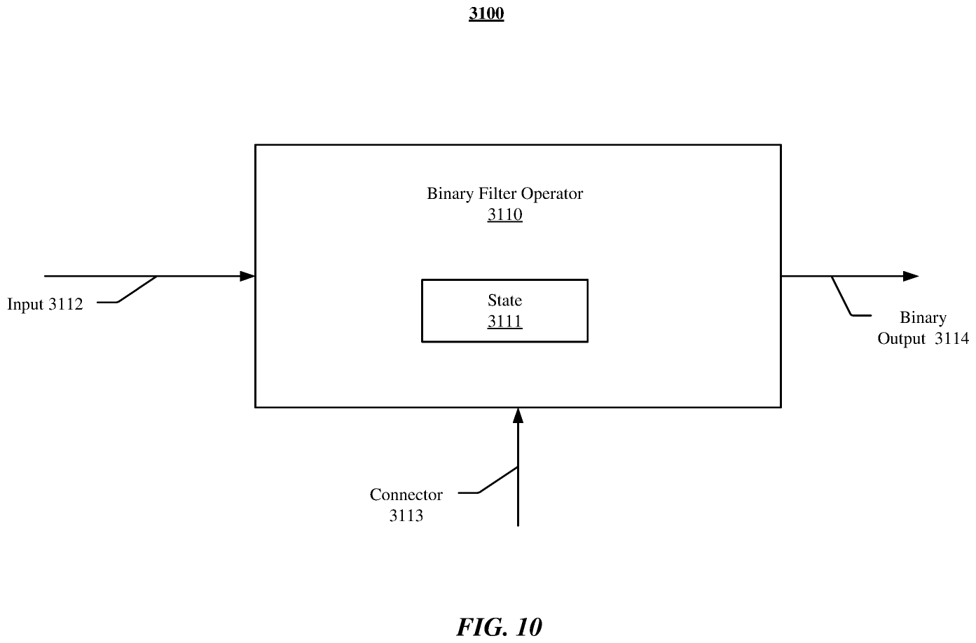

FIG. 10 illustrates an example binary filter operator scheme 3100. As an example and not by way of limitation, the binary filter operator 3110 may be associated with an input 3102, a binary output 3104, a connector 3103, and a state module 3101. The connector 3113 associated with the binary operator 3110 may be used to access any dependent information during the processing. The dependent information may be the output of another operator. Each binary operator may be stateful, but it is optional.

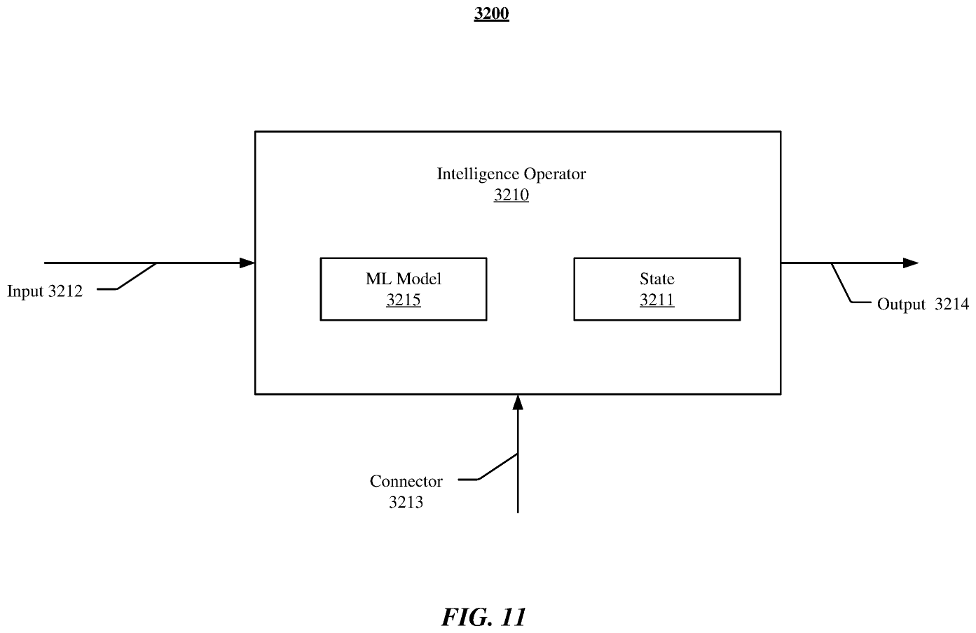

FIG. 11 illustrates an example intelligence operator scheme 3200. In particular embodiments, the intelligent operator may include built-in ML models for filtering and predicting. As an example and not by way of limitation, the intelligence operator 3210 may be associated with a state module 3211, an input 3212, a connector 3213, an output 3214, and a ML model 3215. The connector 3213 associated with the intelligence operator 3210 may be used to access any dependent information during the processing. The dependent information may be the output of another operator. Each intelligence operator may be stateful, but it is optional. Each intelligence operator may include a built-int ML model for processing the input information and determine the output information.

In particular embodiments, the system may use a policy algorithm which may refer to a process or set of rules for a module of access control methods. An algorithm may be composited by a set of policy operators for a certain access control method. There may be different policy algorithms for different purposes, for example, role-based policy algorithm, attribute-based policy algorithm, role-and-attribute-mixed policy algorithm, etc. The system may define and generate a policy algorithm by using operators and connectors. The system may use a policy algorithm or multiple policy algorithms to implement an access control method. A policy algorithm may contain predefined logic for reusing and sharing. A policy algorithm may include flow controls for performing multiple operators in parallel or sequence. For example, for three operations of A, B, C, the algorithm may perform operations A and B in parallel and use the results of both or either of them to serve the operation C as an input. Due to complex situations, some policy algorithms may be defined by ML models using automatic machine learning, which can be implemented using different methods. For example, the automatic machine-learning may be implemented using existing datasets and controlling resources to select ML algorithms and generate a ML model. As another example, the automatic machine-learning may be implemented by transferring learning using existing policy ML model to generate a new model based on its specific datasets. As another example, the automatic machine-learning may be implemented by reinforcement learning dynamically interacting with the context to generate a new model.

In particular embodiments, the system may use policy flow for access control management. A policy flow may refer to a a run-time logic for one or a set of policy algorithms. An access control method may be implemented by a policy flow. The system may use a configurable mechanism to define a policy flow dynamically. The system may use an intelligent engine in the system to monitor the policy flows and detect anomaly. Also, the intelligent engine in the system may prevent some trends to prevent potential vulnerabilities. In particular embodiments, the system may run a policy flow in a policy module or multiple policy modules for distributed processing. A policy module may be stateful, but that is optional.

In particular embodiments, the system may use a logically centralized but physically distributed policy engine. The policy engine may orchestrate all policy modules and policy flows. The system may have a global state store in the policy engine. The engine may serve the requests for resource access and may be responsible to distribute to the related policy flows for access results. The system may be in charge of the scalability and reliability of the policy engine. The policy engine may include policy knowledge and policy intelligence components for managing policy knowledge and conducting intelligent machine learning. The policy knowledge may be used for incremental learning and transfer learning.

In particular embodiments, the system may have two types of states: global state and local state. Both policy operator and policy module may have a local state. Policy algorithm, policy flow, and policy engine may have a global state. The global state in a policy algorithm may be shared by all policy operators in the algorithm. The global state in the policy flow may be shared by all operators and algorithms internally. The global state in the policy engine may be shared by all policy modules and others. All these states may be optional and may be reset selectively. The states may be policy, historical access information, and controlling attributes. Further, the policy flow configurations may be stored in the state as well for system simplicity, but the configuration state and runtime state may be separated for the security reason. In particular embodiments, the intelligent control management system may include intelligence logics or functions for at least three areas including intelligent policy operator, intelligent policy algorithm, and intelligent policy flow. Both intelligent policy algorithms and intelligent policy flow may be supported by policy intelligence engine.

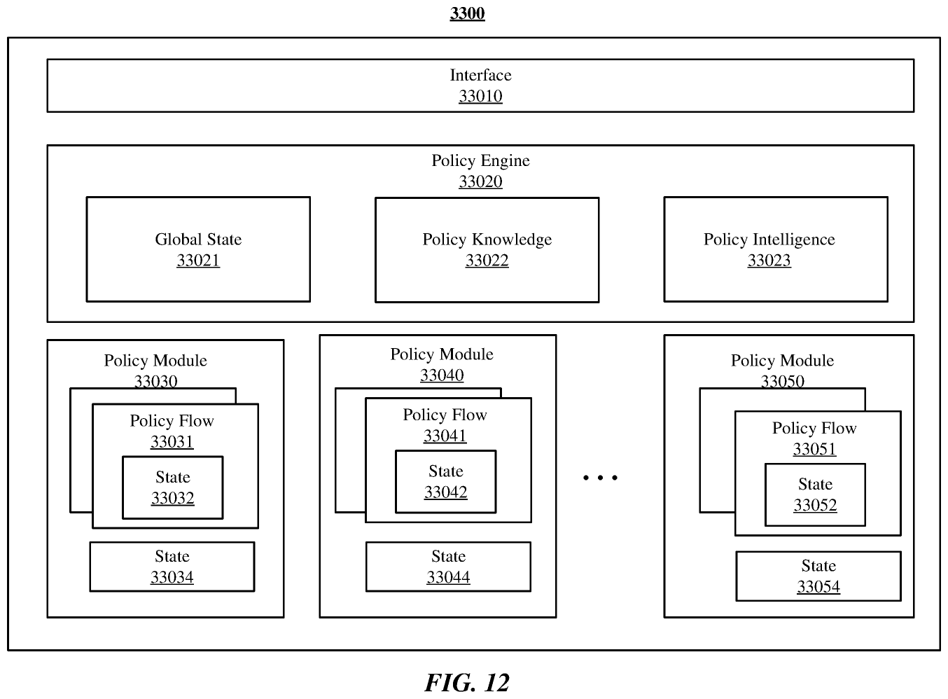

FIG. 12 illustrates an example intelligent control management system 3300. As an example and not by way of limitation, the intelligent control management system 3300 may include an interface 33010, a policy engine 32020, and a number of policy modules (e.g., 33030, 33040, 33050). The policy engine 33020 may include a global state module 33021, a policy knowledge module 33022, a policy intelligence module 33023, etc. Each policy module (e.g., 33030, 33040, 33050) may include a state module (e.g., 33034, 33044, 33054) and a number of embedded policy flow (e.g., 33031, 33041, 33051). For example, the policy module 33030 may include the policy flow 33031, the policy module 33040 may include the policy 33041, and the policy module 33050 may include policy flow 33051. Each policy flow may include a date module (e.g., 33032, 33042, 33052). For example, the policy flow 33031 may include the state module 33032, the policy flow 33041 may include the policy the state module 33042, and the policy flow 33051 may include the state module 33052.

In particular embodiments, the intelligent control management system may use policy flow and policy algorithm for access control. The system may dynamically change any control module. The system may share both policy algorithms and policy operators for different access controls. With algorithm templates, the system may quickly implement many access control methods. For example, the system may implement many access controls by a policy decision tree.

In particular embodiments, both local and global states may be used to speed up the processing of access control. The stateful information may be used for historical checks for some logics. A policy algorithm may be run in multiple policy modules for efficiency and scalability. The global state may reduce access latency. In particular embodiments, the system may use the state mechanism to enable iterative control processing, which is similar to machine learning RNN for memory processing. The system may use some access control results to affect the future access controls.

In particular embodiments, the system may use various policy operators and flexible policy algorithms to support different access control methods as well as mixed methods including, for example, both RBAC and ABAC at the same time. In particular embodiments, the system may use control encapsulation and policy polymorphism in the intelligent control management system for access control. Some control logics may be encapsulated as a single unit and may be reused by other methods and transferred to another module. The system may use the policy polymorphism to extend control encapsulation and allow policy algorithms to be inherited and extended.

In particular embodiments, the system may use policy operator and policy algorithm to run with other computing engines to enable policy awareness during the computing and data processing. In particular embodiments, the system may use policy programming with policy polymorphism and rich policy operators and algorithms for access control. In particular embodiments, the system may use automatic ML through policy intelligence to generate intelligent policy algorithms at scale. In particular embodiments, the system may use policy knowledge to enable incremental learning.

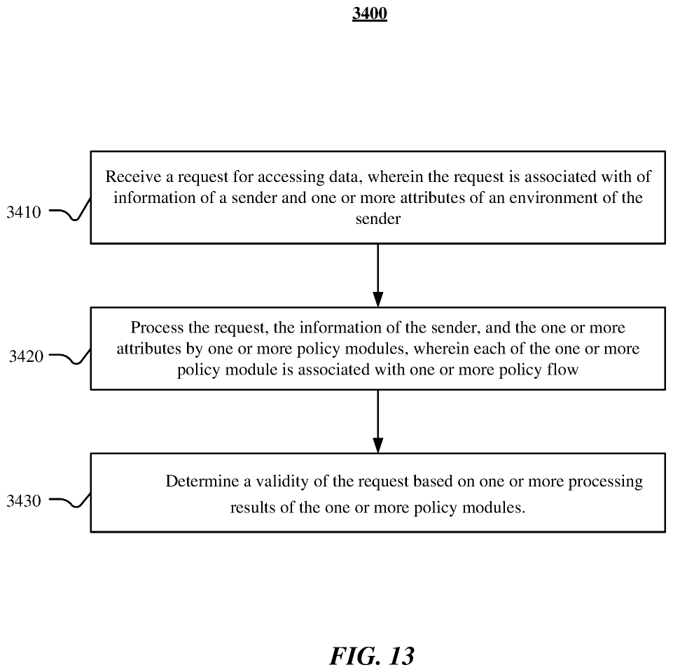

FIG. 13 illustrates an example method 3400 for using intelligent control management system for access control. The method may begin at step 3410, where a computing system may receive a request for accessing data, wherein the request is associated with of information of a sender and one or more attributes of an environment of the sender. At step 3420, the system may process the request, the information of the sender, and the one or more attributes by one or more policy modules, wherein each of the one or more policy module is associated with one or more policy flow. At step 3430, the system may determine a validity of the request based on one or more processing results of the one or more policy modules. In particular embodiments, the one or more policy modules may be associated with a policy engine and the policy engine is associated with a policy knowledge module and a policy intelligence module. In particular embodiments the policy engine may dynamically update policy knowledge based on a self-learning process, a transfer learning process, or a reinforcement learning process associated with one or more machine-learning models.

In particular embodiments, the policy engine may include a global state module, a policy knowledge module, and a policy intelligence module. The system may have a logically centralized but physically distributed policy engine, which may orchestrate all policy modules and policy flows. The policy engine may have a global state and may serve the requests for resource access and may distribute to the related policy flows for access results. The policy engine may use policy knowledge and policy intelligence modules to manage policy knowledge and conducting intelligent machine learning. The system may use the policy knowledge component for incremental learning and transfer learning.

In particular embodiments, the policy module may have a multi-level implementation structure. For example, each policy module may include a number of policy flows, each policy flow may include one or more policy algorithms, and each policy algorithm may include one or more policy operators. A policy flow may include a run-time logic for one or a set of policy algorithms. An access control method may be implemented by one or more policy flows. The system may use a configurable mechanism to define a policy flow dynamically. The intelligent policy engine in the system may monitor the policy flows and detect anomaly. The policy engine may also prevent some trends to prevent potential vulnerabilities. A policy flow may be run in a policy module or multiple policy modules for distributed processing. A module can be optionally stateful. Each policy flow may include one or more policy algorithms.

A policy algorithm may include a set of rules for a module of access control methods. An algorithm may include a set of policy operators for a certain access control method. The system may use different policy algorithms for different purposes, for example, role-based policy algorithm, attribute-based policy algorithm, and role-and-attribute-mixed policy algorithm. The system may define a policy algorithm by using operators and connectors. An access control method may be implemented by a policy algorithm or multiple policy algorithms. A policy algorithm may contain predefined logic for reusing and sharing. A policy algorithm may use flow controls to perform multiple operators in parallel or sequence. For example, for operations of A, B, C, the algorithm may perform A and B in parallel and use the results of both or either of them to serve C as an input. In particular embodiments, for complex situations, the policy algorithms may be defined by ML using auto machine learning, which can be implemented in three methods of self-learning, transfer learning, and reinforcement learning. For example, self-learning method may use its existing datasets and controlling resources to select ML algorithms and generate a ML model. As another example, transfer learning method may use existing policy ML model to generate a new model based on its specific datasets. As another example, reinforcement learning method may dynamically interact with the context to generate a new model. Each policy algorithm may include one or more policy operators.

A policy operator may be used for executing a policy and performing a filtering. For example, the system may use different types of policy operators including filtering operator, function operator, computing operator, intelligence operator, etc. In particular embodiments, the system may use a basic operator for security check and filtering, for example, binary filtering operator (BFO), multi-filtering operator (MFO), attribute-based filtering operator (ABFO), etc. The function operator may have some built-in function for a standalone operator, such as, face-recognized operator (FRO), fingerprint operator (FPO), etc. The computing operator may provide a generic operator for any control logic as a unit. The intelligent operator may have ML models built-in for filtering and predicting. Each operator may have a connector which may be used to access any dependent information during the processing. The dependent information may be the output of another operator. Each operator can be stateful, but it is optional.

In particular embodiments, the system may have two types of states: global state and local state. Both policy operator and policy module may have a local state. Policy algorithm, policy flow, and policy engine may have a global state. The global state in a policy algorithm may be shared by all policy operators in the algorithm. The global state in the policy flow may be shared by all operators and algorithms internally. The global state in the policy engine may be shared by all policy modules and others. All these states may optional and can be reset selectively. The states may be related to policy, historical access information, and controlling attributes. The policy flow configurations may be stored in the state as well for system simplicity, but the configuration state and runtime state may be separated for the security reason. The intelligent control management system may have intelligence in at least three areas: intelligent policy operator, intelligent policy algorithm, and intelligent policy flow. Both intelligent policy algorithms and intelligent policy flow may be supported by policy intelligence engine.

Particular embodiments may repeat one or more steps of the method of FIG. 13, where appropriate. Although this disclosure describes and illustrates particular steps of the method of FIG. 13 as occurring in a particular order, this disclosure contemplates any suitable steps of the method of FIG. 13 occurring in any suitable order. Moreover, although this disclosure describes and illustrates an example method for using intelligent control management system for access control including the particular steps of the method of FIG. 13, this disclosure contemplates any suitable method for generating features for using intelligent control management system for access control including any suitable steps, which may include all, some, or none of the steps of the method of FIG. 13, where appropriate. Furthermore, although this disclosure describes and illustrates particular components, devices, or systems carrying out particular steps of the method of FIG. 13, this disclosure contemplates any suitable combination of any suitable components, devices, or systems carrying out any suitable steps of the method of FIG. 13.

Graphs may be used to represent information related to real world systems. However, in some situations, real world systems may include a large number of entities (e.g., represented by nodes) and a collection of interactions (e.g., represented by edges) amongst the entities. Graph representations for such system may be highly expressive and large in size. Graphs may be applied to represent social networks, biological molecules, transactions among accounts, purchase between customers and items, etc. Essentially, graph may include a data structure to store structured knowledge of interconnected data, where queries and analysis may be performed. A graph may be referred to as a heterogeneous graph when the nodes and/or edges are labeled as different types. For example, a first type of nodes may represent employees and a second type of nodes may represent products and the first type of nodes and second type of nodes may be connected by the edges based on their relationship. A graph may be referred to as a nested graph if a node in the graph represents another graph (e.g., a sub-graph).

Graph learning (GL) may be an emerging technique which draws much attention due to the advances in artificial intelligence (AI). Graph learning may enable powerful analysis capability on graph data by extracting valuable hidden information from graph data, bridging the deep neural network (DNN) and graph analysis. Graph learning may be based on graph neural network (GNN). Data warehouse (DW) may play an important role in many businesses for using algorithms to analyze data across sources for business intelligence (BI) and enterprise reporting. Data warehouse may be central repositories of integrated data from one or more disparate sources. Data warehouse may store current and historical data in one single place that are used for creating analytical reports for workers throughout the enterprise. Besides, due to the increasing importance of integrity, security and privacy, various data access policies/permission may be observed in data warehouse, leading to the requirement of policy-aware data analysis.

It is notable that in many situation data may be usually generated from various sources (e.g. products, employees, customers, procurements, etc.), and may be mutually linked rather than isolated. Besides, the data may be at different granularities (e.g. individual, team, region, country, etc.). Therefore, a nested heterogeneous graph may be needed to organize the data in data warehouse for BI analysis. For example, graph learning algorithms/models may be naturally applied to data warehouse for advanced analysis once the data in data warehouse is organized as a graph. Besides, the policy for data access may be represented as attributes on edges between users and data sets.

As the data and analysis become more and more complicated, the data warehouse system may face various challenges. First, items in real worlds may be barely isolated and data for representing these items may be highly linked to each other. Traversal along with data linkages may result in exponentially increased cost in storage and computation, making it impractical for many big data applications. For example, use cases involving graph traversal may include, for example, lineage analysis and lineage propagation learning, state change enforcement in data lineage, upstream and downstream information forecast. Second, data representation may need to have policy-awareness. For example, data analysis in data warehouse may observe various data policies, such as the access permissions and other security/privacy rules. The data representations may need to have different level of access control (e.g., fine/coarse grained access control). The data presentation may have user-resource specific security policies. Third, the data presentations may be heterogeneity in data management and analysis. Although many data are interconnected, data may be extracted from very different sources, and therefore may be described by different schemas. To preserve the interconnection while maintaining the heterogeneous schemas, generating appropriate data representation may lead to a highly complex and expressive data model. Otherwise, the information may not be completely represented.

Fourth, data representation may need to have some granularity in data representation and analysis at scales. For example, the entities and the interaction among the entities may occur at different granularity levels. Hence, the policy may need to be preserved at various granularity levels consistently, without losing the signal or the accessibility. Lastly, the data warehouse system may need to address increasingly growing challenges in data infrastructure for big companies. In particular embodiments, the system may introduce a systematic solution to 1) express the complicated data system holistically and also to 2) enable advanced analytics techniques. To express the complicated data holistically, particular embodiments of the system may support a unified data model that is expected to represent data in a unified manner, describing data of different types using different schemas, representing the ontology of the master data, and handling different granularities in a hierarchical approach. To enable advanced analytics techniques, particular embodiments of the system may need to include advanced analytics compatible to the above mentioned graph-like data model.

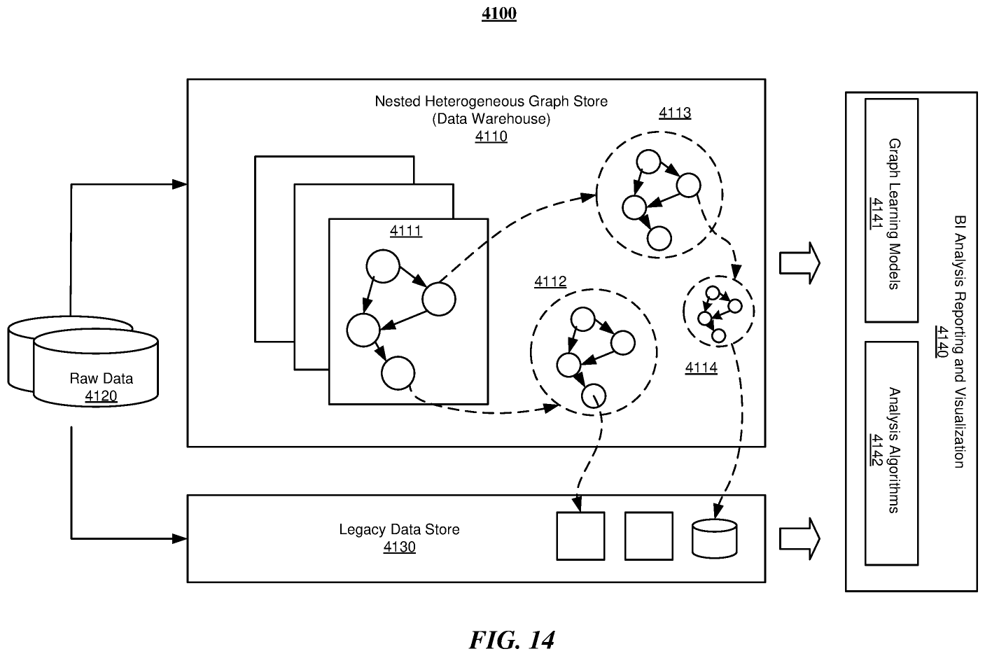

FIG. 14 illustrates an example architecture 4100 of smart data warehouse based on nested heterogenous graphs. In particular embodiments, the system may provide an effective solution of smart data warehouse powered by the nested heterogeneous graphs along with the graph learning models. The nested heterogeneous graph may serve as a unified data model and may natively support various GNN models for advanced data analysis. In particular embodiments, the system may include a number of subsystems or modules including, for example, a nested heterogeneous graph store 4110 (also referred to as data warehouse), a database for raw data 4120, a legacy data store 4130, an analysis reporting and visualization module 4140. The nested heterogeneous graph store 4110 may include a number of nested heterogenous graphs. For example, the graph 4111 may include a number of nodes some of which may correspond to respective sub-graphs (e.g., 4112, 4113). The node in the sub-graph (e.g., 4113) may further have one or more nodes corresponding to their own next sub-level of sub-graphs (e.g., 4114). The legacy data store 4130 may store some of the data or other related information associated with these graphs. The analysis reporting and visualization module may include one or more graph learning models (e.g., 4141) and one or more analysis algorithms (e.g., 4142).

In particular embodiments, the system may work at high level following a workflow. The system may feed the raw data into a data warehouse, with some metadata stored in the system, going through natural language processing (NLP) based preprocessing (Intelli-ETL). The system may represent the data by some elements in nested heterogeneous graphs (NHG) and/or some in the legacy store. The system may use GNN models and graph analysis algorithms for analyzing the data, providing reports and visualized results for business analysis.

In particular embodiments, the data warehouse system may use NHG to manage data, holistically representing entries of various types as well as the interaction among the data. Each graph instance in the NHG store may be associated with some features including, for example, but not limited to, being heterogeneous or/and nested. For example, each instance may be a heterogeneous graph, where the different colors of the nodes represent different types of entities, linked by edges to represent the interaction. As another example, both nodes and edges may be annotated by attributes/properties. The graph may be nested, so that a node can represent another graph instance recursively as a hierarchical representation of data at different granularity levels. A node at any level may point to any data object in the legacy data store, such as a relational table or a JSON doc, making the system highly compatible with existing data warehouse systems. Graph neural network (GNN) models and graph analysis algorithms may be natively supported because the data in the system may be represented by a graph. Note that the nested heterogeneous graph itself may be technically a heterogeneous graph as well.

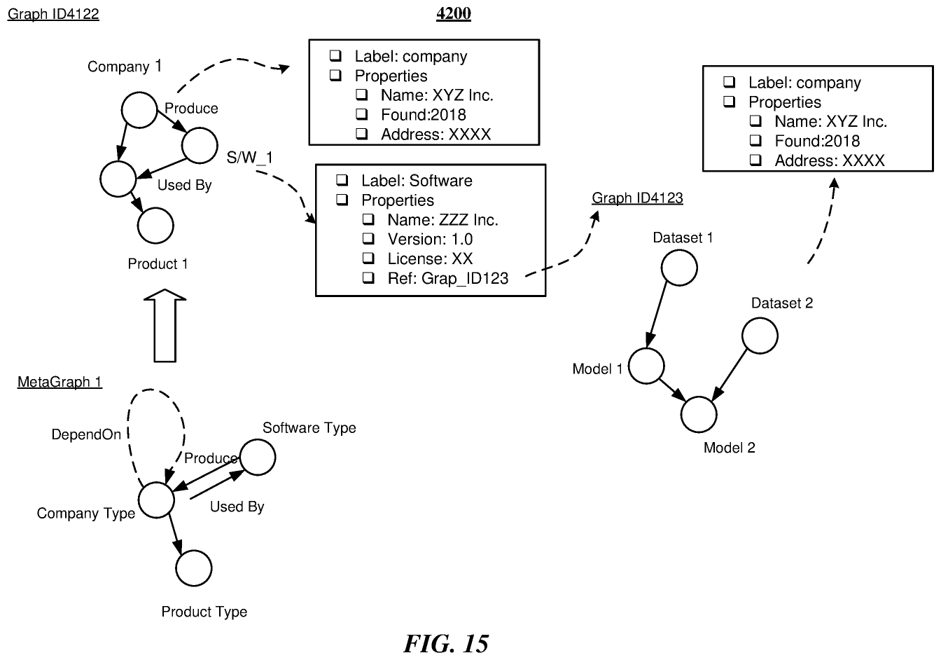

FIG. 15 illustrates an example unified data model 4200 based on nested heterogeneous graph. In particular embodiments, the system may use the nested heterogeneous graph as the unified data model to holistically organize data, including the heterogeneity in data types, interaction among items, metadata of data instances, hierarchical view of different granularities. As an example and not by way of limitation, the instance of a NHG (e.g., graph ID 4112) may follow a template metadata (e.g. MetaGraph_1) that defines the data (node) types and the allowed interaction (edge) types. Note that the edges may be usually directed since the relationship may not be symmetric. Such a graph may be referred to as a heterogeneous graph. Each instance of a NHG may a unique ID (e.g. Graph_ID4122) that defines the namespace, under which each node of the graph may be uniquely identified as well. Two nodes (source and target) may use used to define an edge. Each node and edge may have a type category according to the corresponding label (e.g. CompanyType). Each type may have its schema to describe the properties. For example, every node of type Company may have the same set of properties such as Name, Found time, Address, etc., in this particular example. Values may be optional according to use cases. This may be referred to as the labeled property graph data model. A property may be linked to another graph instance, referred by the graph identity, so that the heterogeneous graph may be nested to implement the NHG. This is illustrated by the Software node in Graph_ID4122, which may represent the graph of Graph_ID4123 that defines the internal structure of the software.

Graph neural network (GNN) models and graph analysis algorithms may be natively supported since the data can be managed as graphs (or NHGs, more specifically). Graph algorithms may offer rich analysis capabilities, shedding lights to the insight of the business data. Some typical graph analysis to enhance the data warehouse may include community detection to find similar entities, path reachability analysis to propagate information, link prediction to find latent connections, and the anomaly subgraph pattern detection to prevent abnormal operations. The natively supported graph analysis may address the efficiency concern in traditional relational data organization, especially when the operation involves deep traversal of graphs that can incur exponentially increased cost for table joins. For graphs, the system may provide a solution that is much efficient and straightforward to implement.

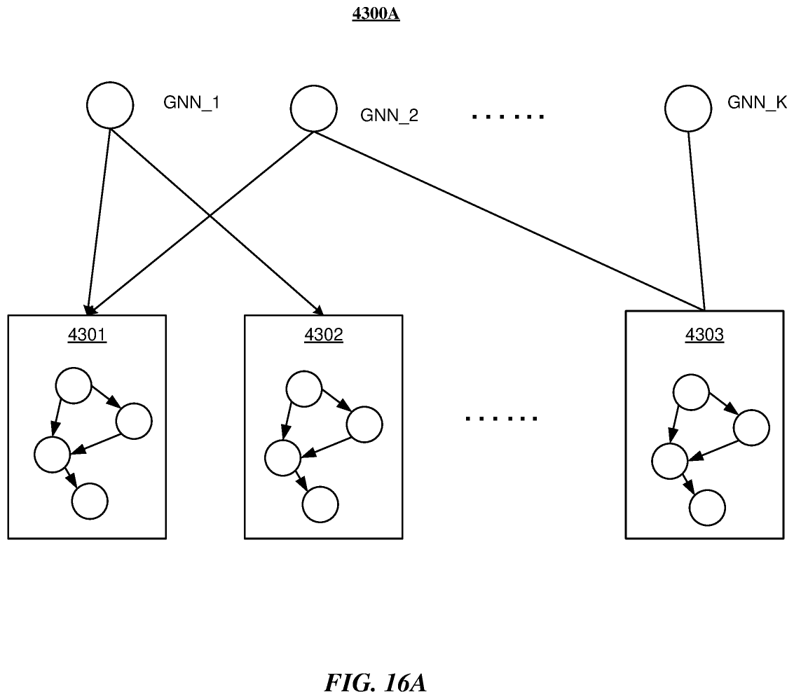

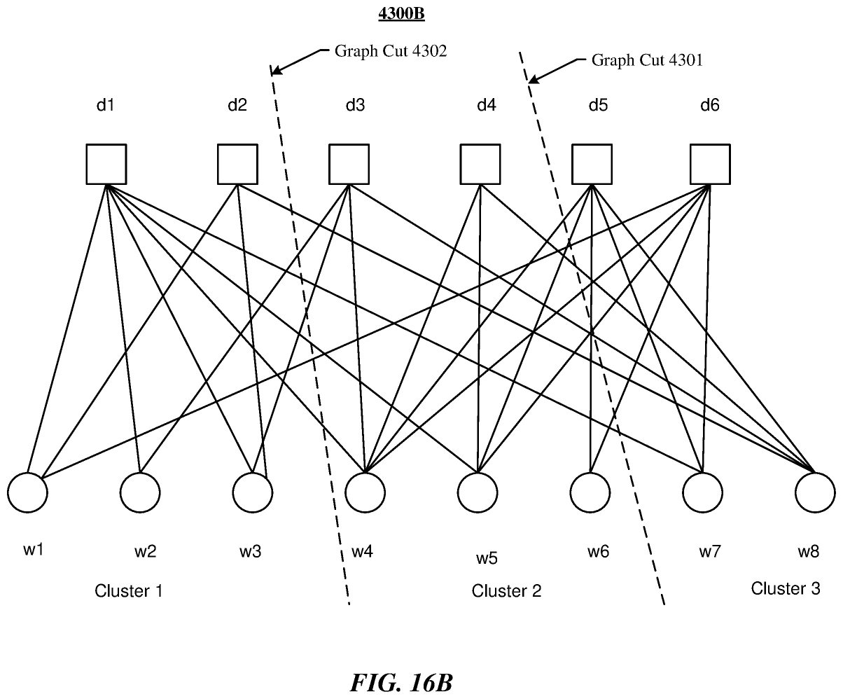

FIG. 16A illustrates an example bipartite graph 4300. FIG. 16B illustrates clustered results on the bipartite graph. In particular embodiments, the system may provide an effective solution to modernize data warehouse. The system may support data driven warehouse optimization, policy-aware graph learning, rebuilding social network data in data warehouse, data warehouse knowledge brain intelligence, etc. The system may use metadata to manage the interaction between NGH instances (e.g., 4301, 4302, 4303) and models/algorithms (e.g., GNN_1, GNN_2, GNN_K) for BI analysis. The interactions may be captured by a bipartite graph as illustrated in FIG. 25A, where a node may be a model/algorithm for analyzing the data, or a data channel added to the system. The edge may indicate a particular model/algorithm that is used for processing the data from a given data source. Since a bipartite graph itself may be a simplified NHG, the same infrastructure in the system may be used. Once the system performs clustering on the bipartite graph, the system may generate groups of relevant models and graph instances. The system may generate recommendations for useful models to users who own some newly uploaded data. Similarly, the system may identify relevant graph instances that may be possibly merged to optimize the efficiency of the data platform.

In particular embodiments, the graph may be associated with policy information, such as the privacy retention policy and the security ACL tags. Using a NHG, the policy information may not be required to be replicated to all the related datasets like what the current policy enforcement mechanism does. There could be a domain scope for a graph or a subgraph, where the policy information can be associated. Thus, any data moves in that scope may not need to have extra effort for policy propagation and enforcement. If a dataset with a policy moves out of the scope, the policy information may be tagged to another scope or embedded in the graph node. Further, the system can enable graph learning on policy information, such as anomaly detection.

Social network data warehouses and other data warehouses may be different in many ways. For example, both type of data warehouse may include Hive storage, computing engines, data pipelines, etc. However, the smart nested heterogeneous graph may be used to rebuild the social network in the data warehouse for effective analysis and learning. The graph may enable the data in data warehouse and may connect it to the original social network. The nested graph may allow meaningful information to be directly associated with the entities/relationships, such as “Like”, “Ads click,” etc.

In particular embodiments, with the above capabilities, the system may include a data warehouse knowledge brain (e.g., implemented by a model/algorithm) with online learning capability. Traditional data warehouse may be discrete with information silos, though it can be filled with different tools. However, in some situations, the methods or tools may be relatively independent and there may be no incremental learning mechanism. The nested heterogeneous graph (NHG) may serve as a knowledge brain for the data warehouse with online learning. There may be a number of main use cases for the knowledge brain. For example, the system may (e.g., using the knowledge brain) serve a rich graph knowledge base for all tools mentioned in the above for reducing information silos allowing these tools to leverage from each other (or previous tasks) with the centralized knowledge base. As another example, the system may (e.g., using the knowledge brain) perform online graph learning for finding data warehouse anomaly (resources and states) and other graph learning common use cases. As another example, the system may (e.g., using the knowledge brain) apply policy and other ML algorithms on top of NHG, for example, enable CNN with rich features from NHG.

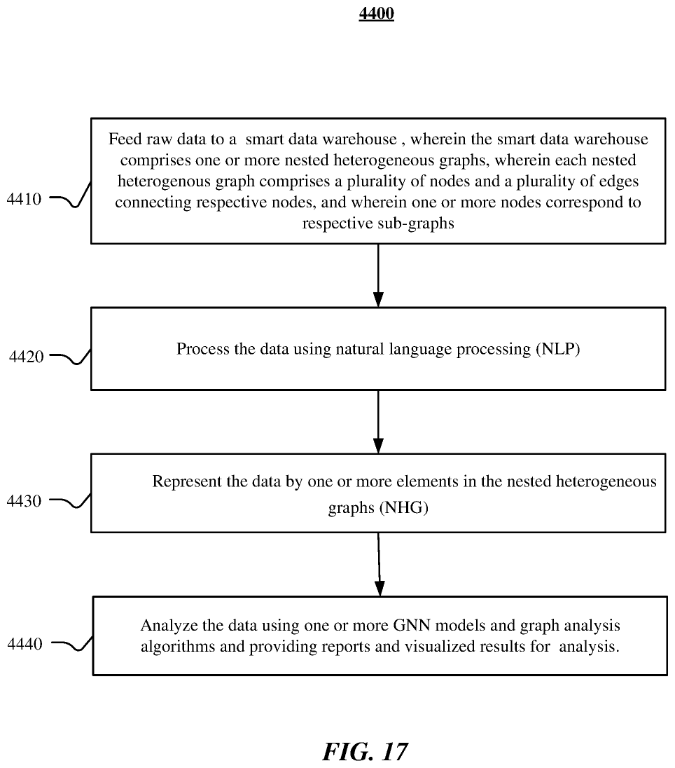

FIG. 17 illustrates an example method 4400 for using smart data warehouse based on nested heterogeneous graphs to analyze data. The method may begin at step 4410, where a computer system may feed raw data to a smart data warehouse system. The smart data warehouse may include one or more nested heterogeneous graphs. Each nested heterogenous graph may include a number of nodes and a number of edges connecting respective nodes. One or more nodes in one or more nested heterogeneous graphs may correspond to respective sub-graphs. At step 4420, the system may preprocess the data using natural language processing (NLP) algorithms. At step 4430, the system may represent the data by some elements in nested heterogeneous graphs (NHG) and/or some in the legacy store. At step 4440, the system may use GNN models and graph analysis algorithms for analyzing the data and providing reports and visualized results for analysis.

In particular embodiments, the system may include a number of subsystems or modules including, for example, a nested heterogeneous graph store (also referred to as data warehouse), a database for raw data, a legacy data store, an analysis reporting and visualization module. The nested heterogeneous graph store may include a number of nested heterogenous graphs. For example, the graph may include a number of nodes some of which may correspond to respective sub-graphs. The node in the sub-graph may further have one or more nodes corresponding to their own next sub-level of sub-graphs. The legacy data store may store some of the data or other related information associated with these graphs. The analysis reporting and visualization module may include one or more graph learning models and one or more analysis algorithms.

In particular embodiments, the data warehouse system may use NHG to manage data, holistically representing entries of various types as well as the interaction among the data. The graph may be nested, and a node may represent another graph instance recursively as a hierarchical representation of data at different granularity levels. The system may use the nested heterogeneous graph as the unified data model to holistically organize data, including the heterogeneity in data types, interaction among items, metadata of data instances, hierarchical view of different granularities. The system may use graph neural network (GNN) models and graph analysis algorithms to analyze the data. Graph analysis to enhance the data warehouse may include community detection to find similar entities, path reachability analysis to propagate information, link prediction to find latent connections, and the anomaly subgraph pattern detection to prevent abnormal operations.

The system may support data driven warehouse optimization, policy-aware graph learning, rebuilding social network data in data warehouse, data warehouse knowledge brain intelligence, etc. The system may use metadata to manage the interaction between NGH instances and models/algorithms for BI analysis. Once the system performs clustering on the bipartite graph, the system may generate groups of relevant models and graph instances. The system may generate recommendations for useful models to users who own some newly uploaded data. Similarly, the system may identify relevant graph instances that may be possibly merged to optimize the efficiency of the data platform. The graph may be associated with policy information, such as the privacy retention policy and the security ACL tags. Using a NHG, the policy information may not be required to be replicated to all the related datasets like what the current policy enforcement mechanism does. There could be a domain scope for a graph or a subgraph, where the policy information can be associated. Thus, any data moves in that scope may not need to have extra effort for policy propagation and enforcement. If a dataset with a policy moves out of the scope, the policy information may be tagged to another scope or embedded in the graph node. Further, the system can enable graph learning on policy information, such as anomaly detection.

Smart nested heterogeneous graph may be used to rebuild the social network in the data warehouse for effective analysis and learning. The graph may enable the data in data warehouse and may connect it to the original social network. The nested graph may allow meaningful information to be directly associated with the entities/relationships, such as “Like”, “Ads click,” etc. The system may include a data warehouse knowledge brain (e.g., implemented by a model/algorithm) with online learning capability. The nested heterogeneous graph (NHG) may serve as a knowledge brain for the data warehouse with online learning. There may be a number of main use cases for the knowledge brain. For example, the system may (e.g., using the knowledge brain) serve a rich graph knowledge base for all tools mentioned in the above for reducing information silos allowing these tools to leverage from each other (or previous tasks) with the centralized knowledge base. As another example, the system may (e.g., using the knowledge brain) perform online graph learning for finding data warehouse anomaly (resources and states) and other graph learning common use cases. As another example, the system may (e.g., using the knowledge brain) apply policy and other ML algorithms on top of NHG, for example, enable CNN with rich features from NHG.

Particular embodiments may repeat one or more steps of the method of FIG. 17, where appropriate. Although this disclosure describes and illustrates particular steps of the method of FIG. 17 as occurring in a particular order, this disclosure contemplates any suitable steps of the method of FIG. 17 occurring in any suitable order. Moreover, although this disclosure describes and illustrates an example method for using smart data warehouse based on nested heterogeneous graphs to analyze data including the particular steps of the method of FIG. 17, this disclosure contemplates any suitable method for generating features for using smart data warehouse based on nested heterogeneous graphs to analyze data including any suitable steps, which may include all, some, or none of the steps of the method of FIG. 17, where appropriate. Furthermore, although this disclosure describes and illustrates particular components, devices, or systems carrying out particular steps of the method of FIG. 17, this disclosure contemplates any suitable combination of any suitable components, devices, or systems carrying out any suitable steps of the method of FIG. 17.

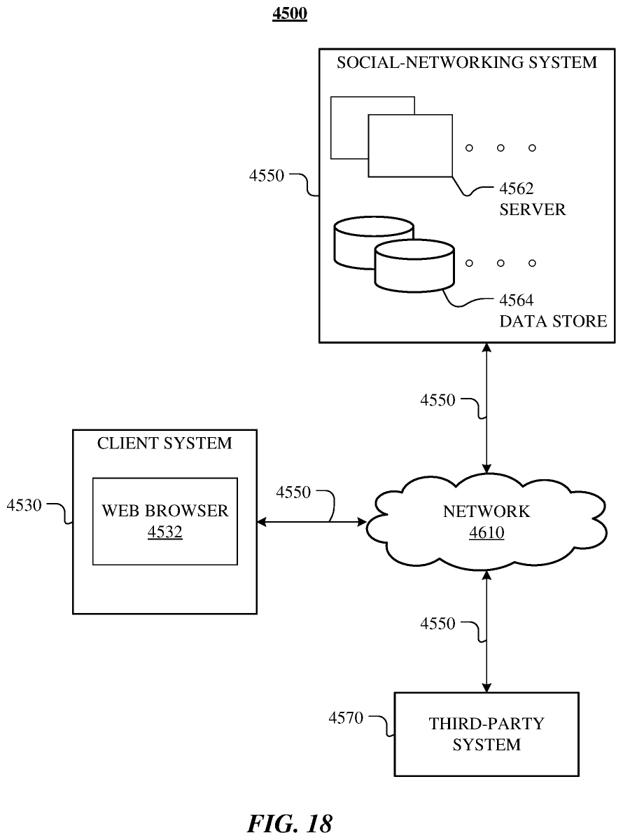

FIG. 18 illustrates an example network environment 4500 associated with a social-networking system. Network environment 4500 includes a client system 4530, a social-networking system 4560, and a third-party system 4570 connected to each other by a network 4510. Although FIG. 27 illustrates a particular arrangement of client system 4530, social-networking system 4560, third-party system 4570, and network 4510, this disclosure contemplates any suitable arrangement of client system 4530, social-networking system 4560, third-party system 4570, and network 4510. As an example and not by way of limitation, two or more of client system 4530, social-networking system 4560, and third-party system 4570 may be connected to each other directly, bypassing network 4510. As another example, two or more of client system 4530, social-networking system 4560, and third-party system 4570 may be physically or logically co-located with each other in whole or in part. Moreover, although FIG. 27 illustrates a particular number of client systems 4530, social-networking systems 4560, third-party systems 4570, and networks 4510, this disclosure contemplates any suitable number of client systems 4530, social-networking systems 4560, third-party systems 4570, and networks 4510. As an example and not by way of limitation, network environment 4500 may include multiple client system 4530, social-networking systems 4560, third-party systems 4570, and networks 4510.

This disclosure contemplates any suitable network 4510. As an example and not by way of limitation, one or more portions of network 4510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 4510 may include one or more networks 4510.

Links 4550 may connect client system 4530, social-networking system 4560, and third-party system 4570 to communication network 4510 or to each other. This disclosure contemplates any suitable links 4550. In particular embodiments, one or more links 4550 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 4550 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 4550, or a combination of two or more such links 4550. Links 4550 need not necessarily be the same throughout network environment 4500. One or more first links 4550 may differ in one or more respects from one or more second links 4550.

In particular embodiments, client system 4530 may be an electronic device including hardware, software, or embedded logic components or a combination of two or more such components and capable of carrying out the appropriate functionalities implemented or supported by client system 4530. As an example and not by way of limitation, a client system 4530 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 4530. A client system 4530 may enable a network user at client system 4530 to access network 4510. A client system 4530 may enable its user to communicate with other users at other client systems 4530.

In particular embodiments, client system 4530 may include a web browser 4532, and may have one or more add-ons, plug-ins, or other extensions. A user at client system 4530 may enter a Uniform Resource Locator (URL) or other address directing the web browser 4532 to a particular server (such as server 4562, or a server associated with a third-party system 4570), and the web browser 4532 may generate a Hyper Text Transfer Protocol (HTTP) request and communicate the HTTP request to server. The server may accept the HTTP request and communicate to client system 4530 one or more Hyper Text Markup Language (HTML) files responsive to the HTTP request. Client system 4530 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts, combinations of markup language and scripts, and the like. Herein, reference to a webpage encompasses one or more corresponding webpage files (which a browser may use to render the webpage) and vice versa, where appropriate.

In particular embodiments, social-networking system 4560 may be a network-addressable computing system that can host an online social network. Social-networking system 4560 may generate, store, receive, and send social-networking data, such as, for example, user-profile data, concept-profile data, social-graph information, or other suitable data related to the online social network. Social-networking system 4560 may be accessed by the other components of network environment 4500 either directly or via network 4510. As an example and not by way of limitation, client system 4530 may access social-networking system 4560 using a web browser 4532, or a native application associated with social-networking system 4560 (e.g., a mobile social-networking application, a messaging application, another suitable application, or any combination thereof) either directly or via network 4510. In particular embodiments, social-networking system 4560 may include one or more servers 4562. Each server 4562 may be a unitary server or a distributed server spanning multiple computers or multiple datacenters. Servers 4562 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 4562 may include hardware, software, or embedded logic components or a combination of two or more such components for carrying out the appropriate functionalities implemented or supported by server 4562. In particular embodiments, social-networking system 4560 may include one or more data stores 4564. Data stores 4564 may be used to store various types of information. In particular embodiments, the information stored in data stores 4564 may be organized according to specific data structures. In particular embodiments, each data store 4564 may be a relational, columnar, correlation, or other suitable database. Although this disclosure describes or illustrates particular types of databases, this disclosure contemplates any suitable types of databases. Particular embodiments may provide interfaces that enable a client system 4530, a social-networking system 4560, or a third-party system 4570 to manage, retrieve, modify, add, or delete, the information stored in data store 4564.

In particular embodiments, social-networking system 4560 may store one or more social graphs in one or more data stores 4564. In particular embodiments, a social graph may include multiple nodes—which may include multiple user nodes (each corresponding to a particular user) or multiple concept nodes (each corresponding to a particular concept)—and multiple edges connecting the nodes. Social-networking system 4560 may provide users of the online social network the ability to communicate and interact with other users. In particular embodiments, users may join the online social network via social-networking system 4560 and then add connections (e.g., relationships) to a number of other users of social-networking system 4560 to whom they want to be connected. Herein, the term “friend” may refer to any other user of social-networking system 4560 with whom a user has formed a connection, association, or relationship via social-networking system 4560.

In particular embodiments, social-networking system 4560 may provide users with the ability to take actions on various types of items or objects, supported by social-networking system 4560. As an example and not by way of limitation, the items and objects may include groups or social networks to which users of social-networking system 4560 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 4560 or by an external system of third-party system 4570, which is separate from social-networking system 4560 and coupled to social-networking system 4560 via a network 4510.

In particular embodiments, social-networking system 4560 may be capable of linking a variety of entities. As an example and not by way of limitation, social-networking system 4560 may enable users to interact with each other as well as receive content from third-party systems 4570 or other entities, or to allow users to interact with these entities through an application programming interfaces (API) or other communication channels.

In particular embodiments, a third-party system 4570 may include one or more types of servers, one or more data stores, one or more interfaces, including but not limited to APIs, one or more web services, one or more content sources, one or more networks, or any other suitable components, e.g., that servers may communicate with. A third-party system 4570 may be operated by a different entity from an entity operating social-networking system 4560. In particular embodiments, however, social-networking system 4560 and third-party systems 4570 may operate in conjunction with each other to provide social-networking services to users of social-networking system 4560 or third-party systems 4570. In this sense, social-networking system 4560 may provide a platform, or backbone, which other systems, such as third-party systems 4570, may use to provide social-networking services and functionality to users across the Internet.

In particular embodiments, a third-party system 4570 may include a third-party content object provider. A third-party content object provider may include one or more sources of content objects, which may be communicated to a client system 4530. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 4560 also includes user-generated content objects, which may enhance a user's interactions with social-networking system 4560. User-generated content may include anything a user can add, upload, send, or “post” to social-networking system 4560. As an example and not by way of limitation, a user communicates posts to social-networking system 4560 from a client system 4530. Posts may include data such as status updates or other textual data, location information, photos, videos, links, music or other similar data or media. Content may also be added to social-networking system 4560 by a third-party through a “communication channel,” such as a newsfeed or stream.

In particular embodiments, social-networking system 4560 may include a variety of servers, sub-systems, programs, modules, logs, and data stores. In particular embodiments, social-networking system 4560 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 4560 may also include suitable components such as network interfaces, security mechanisms, load balancers, failover servers, management-and-network-operations consoles, other suitable components, or any suitable combination thereof. In particular embodiments, social-networking system 4560 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 4560 to one or more client systems 4530 or one or more third-party system 4570 via network 4510. The web server may include a mail server or other messaging functionality for receiving and routing messages between social-networking system 4560 and one or more client systems 4530. An API-request server may allow a third-party system 4570 to access information from social-networking system 4560 by calling one or more APIs. An action logger may be used to receive communications from a web server about a user's actions on or off social-networking system 4560. In conjunction with the action log, a third-party-content-object log may be maintained of user exposures to third-party-content objects. A notification controller may provide information regarding content objects to a client system 4530. Information may be pushed to a client system 4530 as notifications, or information may be pulled from client system 4530 responsive to a request received from client system 4530. Authorization servers may be used to enforce one or more privacy settings of the users of social-networking system 4560. A privacy setting of a user determines how particular information associated with a user can be shared. The authorization server may allow users to opt in to or opt out of having their actions logged by social-networking system 4560 or shared with other systems (e.g., third-party system 4570), such as, for example, by setting appropriate privacy settings. Third-party-content-object stores may be used to store content objects received from third parties, such as a third-party system 4570. Location stores may be used for storing location information received from client systems 4530 associated with users. Advertisement-pricing modules may combine social information, the current time, location information, or other suitable information to provide relevant advertisements, in the form of notifications, to a user.

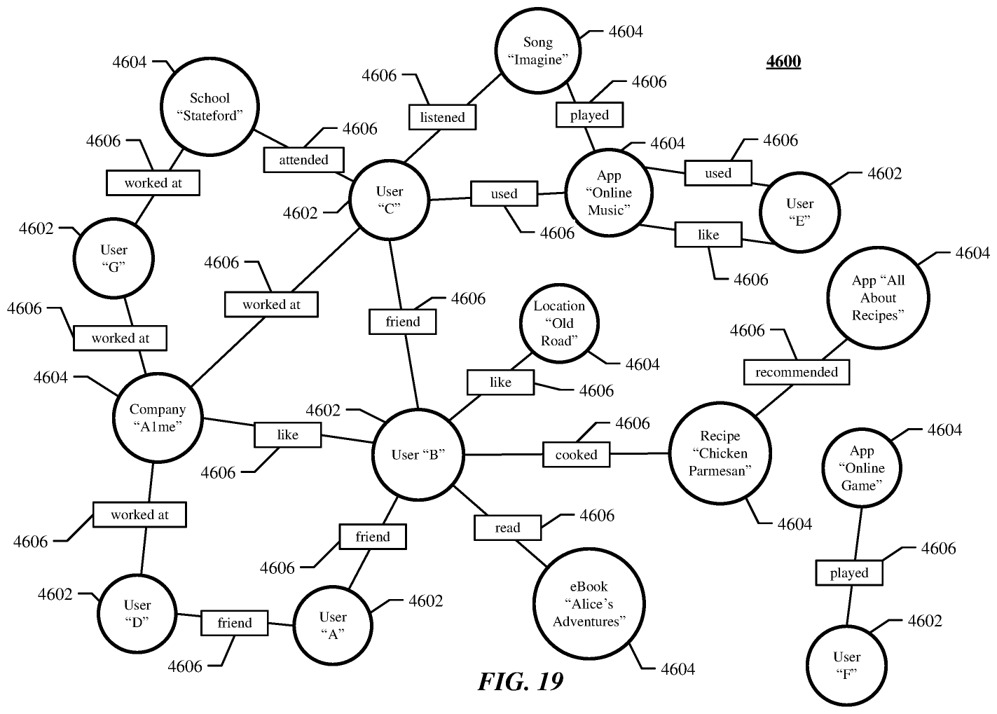

FIG. 19 illustrates example social graph 4600. In particular embodiments, social-networking system 4560 may store one or more social graphs 4600 in one or more data stores. In particular embodiments, social graph 4600 may include multiple nodes—which may include multiple user nodes 4602 or multiple concept nodes 4604—and multiple edges 4606 connecting the nodes. Each node may be associated with a unique entity (i.e., user or concept), each of which may have a unique identifier (ID), such as a unique number or username. Example social graph 4600 illustrated in FIG. 28 is shown, for didactic purposes, in a two-dimensional visual map representation. In particular embodiments, a social-networking system 4560, client system 4530, or third-party system 4570 may access social graph 4600 and related social-graph information for suitable applications. The nodes and edges of social graph 4600 may be stored as data objects, for example, in a data store (such as a social-graph database). Such a data store may include one or more searchable or queryable indexes of nodes or edges of social graph 4600.

In particular embodiments, a user node 4602 may correspond to a user of social-networking system 4560. As an example and not by way of limitation, a user may be an individual (human user), an entity (e.g., an enterprise, business, or third-party application), or a group (e.g., of individuals or entities) that interacts or communicates with or over social-networking system 4560. In particular embodiments, when a user registers for an account with social-networking system 4560, social-networking system 4560 may create a user node 4602 corresponding to the user, and store the user node 4602 in one or more data stores. Users and user nodes 4602 described herein may, where appropriate, refer to registered users and user nodes 4602 associated with registered users. In addition or as an alternative, users and user nodes 4602 described herein may, where appropriate, refer to users that have not registered with social-networking system 4560. In particular embodiments, a user node 4602 may be associated with information provided by a user or information gathered by various systems, including social-networking system 4560. As an example and not by way of limitation, a user may provide his or her name, profile picture, contact information, birth date, sex, marital status, family status, employment, education background, preferences, interests, or other demographic information. In particular embodiments, a user node 4602 may be associated with one or more data objects corresponding to information associated with a user. In particular embodiments, a user node 4602 may correspond to one or more webpages.

In particular embodiments, a concept node 4604 may correspond to a concept. As an example and not by way of limitation, a concept may correspond to a place (such as, for example, a movie theater, restaurant, landmark, or city); a website (such as, for example, a website associated with social-network system 4560 or a third-party website associated with a web-application server); an entity (such as, for example, a person, business, group, sports team, or celebrity); a resource (such as, for example, an audio file, video file, digital photo, text file, structured document, or application) which may be located within social-networking system 4560 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 4604 may be associated with information of a concept provided by a user or information gathered by various systems, including social-networking system 4560. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 4604 may be associated with one or more data objects corresponding to information associated with concept node 4604. In particular embodiments, a concept node 4604 may correspond to one or more webpages.

In particular embodiments, a node in social graph 4600 may represent or be represented by a webpage (which may be referred to as a “profile page”). Profile pages may be hosted by or accessible to social-networking system 4560. Profile pages may also be hosted on third-party websites associated with a third-party system 4570. As an example and not by way of limitation, a profile page corresponding to a particular external webpage may be the particular external webpage and the profile page may correspond to a particular concept node 4604. Profile pages may be viewable by all or a selected subset of other users. As an example and not by way of limitation, a user node 4602 may have a corresponding user-profile page in which the corresponding user may add content, make declarations, or otherwise express himself or herself. As another example and not by way of limitation, a concept node 4604 may have a corresponding concept-profile page in which one or more users may add content, make declarations, or express themselves, particularly in relation to the concept corresponding to concept node 4604.

In particular embodiments, a concept node 4604 may represent a third-party webpage or resource hosted by a third-party system 4570. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 4530 to send to social-networking system 4560 a message indicating the user's action. In response to the message, social-networking system 4560 may create an edge (e.g., a check-in-type edge) between a user node 4602 corresponding to the user and a concept node 4604 corresponding to the third-party webpage or resource and store edge 4606 in one or more data stores.

In particular embodiments, a pair of nodes in social graph 4600 may be connected to each other by one or more edges 4606. An edge 4606 connecting a pair of nodes may represent a relationship between the pair of nodes. In particular embodiments, an edge 4606 may include or represent one or more data objects or attributes corresponding to the relationship between a pair of nodes. As an example and not by way of limitation, a first user may indicate that a second user is a “friend” of the first user. In response to this indication, social-networking system 4560 may send a “friend request” to the second user. If the second user confirms the “friend request,” social-networking system 4560 may create an edge 4606 connecting the first user's user node 4602 to the second user's user node 4602 in social graph 4600 and store edge 4606 as social-graph information in one or more of data stores 4564. In the example of FIG. 28, social graph 4600 includes an edge 4606 indicating a friend relation between user nodes 4602 of user “A” and user “B” and an edge indicating a friend relation between user nodes 4602 of user “C” and user “B.” Although this disclosure describes or illustrates particular edges 4606 with particular attributes connecting particular user nodes 4602, this disclosure contemplates any suitable edges 4606 with any suitable attributes connecting user nodes 4602. As an example and not by way of limitation, an edge 4606 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 4600 by one or more edges 4606. The degree of separation between two objects represented by two nodes, respectively, is a count of edges in a shortest path connecting the two nodes in the social graph 4600. As an example and not by way of limitation, in the social graph 4600, the user node 4602 of user “C” is connected to the user node 4602 of user “A” via multiple paths including, for example, a first path directly passing through the user node 4602 of user “B,” a second path passing through the concept node 4604 of company “Alme” and the user node 4602 of user “D,” and a third path passing through the user nodes 4602 and concept nodes 4604 representing school “Stateford,” user “G,” company “Alme,” and user “D.” User “C” and user “A” have a degree of separation of two because the shortest path connecting their corresponding nodes (i.e., the first path) includes two edges 4606.

In particular embodiments, an edge 4606 between a user node 4602 and a concept node 4604 may represent a particular action or activity performed by a user associated with user node 4602 toward a concept associated with a concept node 4604. As an example and not by way of limitation, as illustrated in FIG. 28, a user may “like,” “attended,” “played,” “listened,” “cooked,” “worked at,” or “watched” a concept, each of which may correspond to an edge type or subtype. A concept-profile page corresponding to a concept node 4604 may include, for example, a selectable “check in” icon (such as, for example, a clickable “check in” icon) or a selectable “add to favorites” icon. Similarly, after a user clicks these icons, social-networking system 4560 may create a “favorite” edge or a “check in” edge in response to a user's action corresponding to a respective action. As another example and not by way of limitation, a user (user “C”) may listen to a particular song (“Imagine”) using a particular application (a third-party online music application). In this case, social-networking system 4560 may create a “listened” edge 4606 and a “used” edge (as illustrated in FIG. 28) between user nodes 4602 corresponding to the user and concept nodes 4604 corresponding to the song and application to indicate that the user listened to the song and used the application. Moreover, social-networking system 4560 may create a “played” edge 4606 (as illustrated in FIG. 28) between concept nodes 4604 corresponding to the song and the application to indicate that the particular song was played by the particular application. In this case, “played” edge 4606 corresponds to an action performed by an external application (the third-party online music application) on an external audio file (the song “Imagine”). Although this disclosure describes particular edges 4606 with particular attributes connecting user nodes 4602 and concept nodes 4604, this disclosure contemplates any suitable edges 4606 with any suitable attributes connecting user nodes 4602 and concept nodes 4604. Moreover, although this disclosure describes edges between a user node 4602 and a concept node 4604 representing a single relationship, this disclosure contemplates edges between a user node 4602 and a concept node 4604 representing one or more relationships. As an example and not by way of limitation, an edge 4606 may represent both that a user likes and has used at a particular concept. Alternatively, another edge 4606 may represent each type of relationship (or multiples of a single relationship) between a user node 4602 and a concept node 4604 (as illustrated in FIG. 28 between user node 4602 for user “E” and concept node 4604 for “online music application”).

In particular embodiments, social-networking system 4560 may create an edge 4606 between a user node 4602 and a concept node 4604 in social graph 4600. As an example and not by way of limitation, a user viewing a concept-profile page (such as, for example, by using a web browser or a special-purpose application hosted by the user's client system 4530) may indicate that he or she likes the concept represented by the concept node 4604 by clicking or selecting a “Like” icon, which may cause the user's client system 4530 to send to social-networking system 4560 a message indicating the user's liking of the concept associated with the concept-profile page. In response to the message, social-networking system 4560 may create an edge 4606 between user node 4602 associated with the user and concept node 4604, as illustrated by “like” edge 4606 between the user and concept node 4604. In particular embodiments, social-networking system 4560 may store an edge 4606 in one or more data stores. In particular embodiments, an edge 4606 may be automatically formed by social-networking system 4560 in response to a particular user action. As an example and not by way of limitation, if a first user uploads a picture, watches a movie, or listens to a song, an edge 4606 may be formed between user node 4602 corresponding to the first user and concept nodes 4604 corresponding to those concepts. Although this disclosure describes forming particular edges 4606 in particular manners, this disclosure contemplates forming any suitable edges 4606 in any suitable manner.

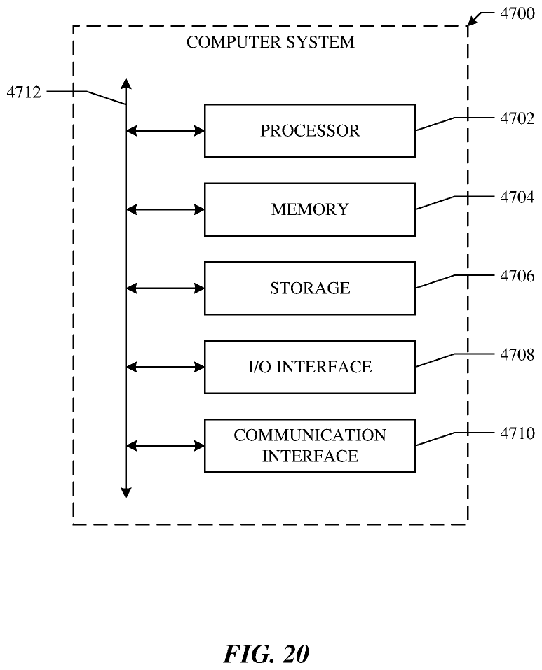

FIG. 20 illustrates an example computer system 4700. In particular embodiments, one or more computer systems 4700 perform one or more steps of one or more methods described or illustrated herein. In particular embodiments, one or more computer systems 4700 provide functionality described or illustrated herein. In particular embodiments, software running on one or more computer systems 4700 performs one or more steps of one or more methods described or illustrated herein or provides functionality described or illustrated herein. Particular embodiments include one or more portions of one or more computer systems 4700. Herein, reference to a computer system may encompass a computing device, and vice versa, where appropriate. Moreover, reference to a computer system may encompass one or more computer systems, where appropriate.

This disclosure contemplates any suitable number of computer systems 4700. This disclosure contemplates computer system 4700 taking any suitable physical form. As example and not by way of limitation, computer system 4700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 4700 may include one or more computer systems 4700; be unitary or distributed; span multiple locations; span multiple machines; span multiple data centers; or reside in a cloud, which may include one or more cloud components in one or more networks. Where appropriate, one or more computer systems 4700 may perform without substantial spatial or temporal limitation one or more steps of one or more methods described or illustrated herein. As an example and not by way of limitation, one or more computer systems 4700 may perform in real time or in batch mode one or more steps of one or more methods described or illustrated herein. One or more computer systems 4700 may perform at different times or at different locations one or more steps of one or more methods described or illustrated herein, where appropriate.

In particular embodiments, computer system 4700 includes a processor 4702, memory 4704, storage 4706, an input/output (I/O) interface 4708, a communication interface 4710, and a bus 4712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 4702 includes hardware for executing instructions, such as those making up a computer program. As an example and not by way of limitation, to execute instructions, processor 4702 may retrieve (or fetch) the instructions from an internal register, an internal cache, memory 4704, or storage 4706; decode and execute them; and then write one or more results to an internal register, an internal cache, memory 4704, or storage 4706. In particular embodiments, processor 4702 may include one or more internal caches for data, instructions, or addresses. This disclosure contemplates processor 4702 including any suitable number of any suitable internal caches, where appropriate. As an example and not by way of limitation, processor 4702 may include one or more instruction caches, one or more data caches, and one or more translation lookaside buffers (TLBs). Instructions in the instruction caches may be copies of instructions in memory 4704 or storage 4706, and the instruction caches may speed up retrieval of those instructions by processor 4702. Data in the data caches may be copies of data in memory 4704 or storage 4706 for instructions executing at processor 4702 to operate on; the results of previous instructions executed at processor 4702 for access by subsequent instructions executing at processor 4702 or for writing to memory 4704 or storage 4706; or other suitable data. The data caches may speed up read or write operations by processor 4702. The TLBs may speed up virtual-address translation for processor 4702. In particular embodiments, processor 4702 may include one or more internal registers for data, instructions, or addresses. This disclosure contemplates processor 4702 including any suitable number of any suitable internal registers, where appropriate. Where appropriate, processor 4702 may include one or more arithmetic logic units (ALUs); be a multi-core processor; or include one or more processors 4702. Although this disclosure describes and illustrates a particular processor, this disclosure contemplates any suitable processor.

In particular embodiments, memory 4704 includes main memory for storing instructions for processor 4702 to execute or data for processor 4702 to operate on. As an example and not by way of limitation, computer system 4700 may load instructions from storage 4706 or another source (such as, for example, another computer system 4700) to memory 4704. Processor 4702 may then load the instructions from memory 4704 to an internal register or internal cache. To execute the instructions, processor 4702 may retrieve the instructions from the internal register or internal cache and decode them. During or after execution of the instructions, processor 4702 may write one or more results (which may be intermediate or final results) to the internal register or internal cache. Processor 4702 may then write one or more of those results to memory 4704. In particular embodiments, processor 4702 executes only instructions in one or more internal registers or internal caches or in memory 4704 (as opposed to storage 4706 or elsewhere) and operates only on data in one or more internal registers or internal caches or in memory 4704 (as opposed to storage 4706 or elsewhere). One or more memory buses (which may each include an address bus and a data bus) may couple processor 4702 to memory 4704. Bus 4712 may include one or more memory buses, as described below. In particular embodiments, one or more memory management units (MMUs) reside between processor 4702 and memory 4704 and facilitate accesses to memory 4704 requested by processor 4702. In particular embodiments, memory 4704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 4704 may include one or more memories 4704, where appropriate. Although this disclosure describes and illustrates particular memory, this disclosure contemplates any suitable memory.

In particular embodiments, storage 4706 includes mass storage for data or instructions. As an example and not by way of limitation, storage 4706 may include a hard disk drive (HDD), a floppy disk drive, flash memory, an optical disc, a magneto-optical disc, magnetic tape, or a Universal Serial Bus (USB) drive or a combination of two or more of these. Storage 4706 may include removable or non-removable (or fixed) media, where appropriate. Storage 4706 may be internal or external to computer system 4700, where appropriate. In particular embodiments, storage 4706 is non-volatile, solid-state memory. In particular embodiments, storage 4706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 4706 taking any suitable physical form. Storage 4706 may include one or more storage control units facilitating communication between processor 4702 and storage 4706, where appropriate. Where appropriate, storage 4706 may include one or more storages 4706. Although this disclosure describes and illustrates particular storage, this disclosure contemplates any suitable storage.

In particular embodiments, I/O interface 4708 includes hardware, software, or both, providing one or more interfaces for communication between computer system 4700 and one or more I/O devices. Computer system 4700 may include one or more of these I/O devices, where appropriate. One or more of these I/O devices may enable communication between a person and computer system 4700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 4708 for them. Where appropriate, I/O interface 4708 may include one or more device or software drivers enabling processor 4702 to drive one or more of these I/O devices. I/O interface 4708 may include one or more I/O interfaces 4708, where appropriate. Although this disclosure describes and illustrates a particular I/O interface, this disclosure contemplates any suitable I/O interface.

In particular embodiments, communication interface 4710 includes hardware, software, or both providing one or more interfaces for communication (such as, for example, packet-based communication) between computer system 4700 and one or more other computer systems 4700 or one or more networks. As an example and not by way of limitation, communication interface 4710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 4710 for it. As an example and not by way of limitation, computer system 4700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 4700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 4700 may include any suitable communication interface 4710 for any of these networks, where appropriate. Communication interface 4710 may include one or more communication interfaces 4710, where appropriate. Although this disclosure describes and illustrates a particular communication interface, this disclosure contemplates any suitable communication interface.

In particular embodiments, bus 4712 includes hardware, software, or both coupling components of computer system 4700 to each other. As an example and not by way of limitation, bus 4712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 4712 may include one or more buses 4712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system, comprising:
accessing a machine-learning model comprising a set of model parameters;
accessing first sample data for training the machine-learning model;
training, using a training process, the machine-learning model based on the accessed first sample data, wherein the machine-learning model adjusts one or more model parameters of the set of model parameters during the training process, and wherein the machine-learning model with the adjusted one or more model parameters provides an optimized functionality for processing data.

2. The method of claim 1, wherein the computing system comprises a plurality of trainer nodes, further comprising:
partitioning the machine-learning model comprising the set of model parameters into a plurality of sub-portions each comprising a subset of model parameters;
accessing sample data for training the machine-learning model; and
training the plurality of sub-portions of the machine-learning model on the plurality of trainer nodes excluding synchronization operations for different subsets of model parameters between different sub-portions of the plurality of sub-portions of the machine-learning model.

3. The method of claim 2, wherein each sub-portion of the plurality of sub-portions of the machine-learning model is trained on a separate trainer node.

4. The method of claim 1, further comprising:
accessing second sample data for training the machine-learning model;
determining one or more first information entities for a first data layer based on the second sample data;
determining one or more second information entities for a second data layer based on the second sample data;
determining one or more features based on the one or more first information entities of the first data layer and the one or more second information entities of the second data layer; and
training the machine-learning model based on the one or more features.

5. The method of claim 4, wherein the sample data and the one or more features are cross multiple problem domains.

6. The method of claim 5, wherein the first data layer is a representative layer, and wherein the one or more first information entities comprise one or more of: an attribute entity or a signal entity.

7. The method of claim 5, wherein the second data layer is an artifact layer, and wherein the one or more second information entities comprise one or more of: a feature, a machine-learning model, or a data sample.

8. The method of claim 1, further comprising:
receiving a request for accessing data, wherein the request is associated with information of a sender and one or more attributes of an environment of the sender;
processing the request, the information of the sender, and the one or more attributes by one or more policy modules, wherein each of the one or more policy module is associated with one or more policy flow; and
determining a validity of the request based on one or more processing results of the one or more policy modules.

9. The method of claim 8, wherein the one or more policy modules are associated with a policy engine, and wherein the policy engine is associated with a policy knowledge module and a policy intelligence module.

10. The method of claim 9, wherein the policy engine dynamically updates policy knowledge based on a self-learning process, a transfer learning process, or a reinforcement learning process associated with one or more machine-learning models.

11. The method of claim 1 wherein the computing system comprises a multi-level system architecture, comprising:
a policy engine comprising a policy knowledge module and a policy intelligence module, wherein the policy knowledge module store policy knowledge information and the policy intelligence module comprising logic for processing policy knowledge information stored in the policy knowledge module; and
one or more policy modules, wherein each policy module comprises a plurality of policy flows, wherein each policy flow is associated with one or more policy algorithms, wherein each policy algorithm comprising one or more policy operators and one or more machine-learning models.

12. The method of claim 1, further comprising:
feeding data to a smart data warehouse, wherein the smart data warehouse comprises one or more nested heterogeneous graphs, wherein each nested heterogenous graph comprises a plurality of nodes and a plurality of edges connecting respective nodes, and wherein one or more nodes correspond to respective sub-graphs;
preprocessing the data using natural language processing (NLP) algorithms;
representing the data by one or more elements in the one or more nested heterogeneous graphs (NHG);
analyzing the data, using one or more GNN models and one or more graph analysis algorithms; and
providing reports and visualized results for analysis.
